(19) United States
(12) Patent Application Publication
(10) Pub. No.: US 2026/0268496 A1
(43) Pub. Date: Sep. 10, 2026

(54) VIDEO MODEL FOR MEDICAL 3D SEGMENTATION

(71) Applicant: Align Technology, Inc., San Jose, CA (US)

(72) Inventors: Niko Benjamin Huber, Zug (CH); Shipra Jain, Zurich (CH); Qi Ma, Zurich (CH)

(21) Appl. No.: 19/557,502

(22) Filed: Mar. 5, 2026

Related U.S. Application Data
(60) Provisional application No. 63/768,054, filed on Mar. 6, 2025.

(51) Int. Cl. G06T 7/00; G06T 11/00

(52) U.S. Cl. CPC G06T 7/0016; G06T 11/00; G06T 2207/10021; G06T 2207/10072; G06T 2207/20081; G06T 2207/30008; G06T 2207/30036

(57) ABSTRACT

A method for using a video model for medical three-dimensional (3D) segmentation includes dividing 3D medical image data into one or more two-dimensional (2D) images. The method includes generating a temporal sequence of the plurality of 2D images. The method includes processing the temporal sequence of the a plurality of 2D images using one or more models trained to process videos, the one or more models outputting segmentation information of anatomical structures in the plurality of 2D images. The method includes storing the segmentation information in a datastore. Methods for training the video model are also disclosed.

### RELATED APPLICATIONS

This patent application claims the benefit under 35 U.S.C. § 119(e) of U.S. Provisional Application No. 63/768,054, filed Mar. 6, 2025, which is incorporated by reference herein.

### TECHNICAL FIELD

The instant specification generally relates to systems and methods for image segmentation, and in particular to systems and methods for using a video model for medical three-dimensional (3D) image segmentation.

### BACKGROUND

Dental treatments help patients achieve desired dental and orthodontic outcomes, including straightening teeth, correcting bite problems, closing gaps between teeth, aligning teeth and other oral anatomy, and soon. Such dental treatments often include using dental appliances such as aligners, retainers, braces, and other components to shift the positions of a patient's oral anatomy. Sometimes, in order to accurately generate such appliances, segmented 3D images may be used.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In a first example implementation, a method for using a video model for medical three-dimensional (3D) segmentation includes dividing 3D medical image data into a plurality of two-dimensional (2D) images; generating a temporal sequence of the plurality of 2D images; processing the temporal sequence of the a plurality of 2D images using one or more models trained to process videos, the one or more models outputting segmentation information of anatomical structures in the plurality of 2D images; and storing the segmentation information in a datastore.

In a second example implementation, a method for training a video model for medical 3D segmentation includes obtaining a model pre-trained on a general video dataset; generating a training dataset that includes medical context information by dividing each 3D medical image data item of a plurality of 3D medical image data items into a set of 2D images and, for each set of 2D images, generating a temporal sequence of the set of 2D images; performing further training of the model using the temporal sequence of the set of 2D images from one or more of the 3D medical image data items, the model being trained to perform segmentation of temporal sequences of 2D images generated from 2D medical image data; and storing the trained model in a datastore.

In a third example implementation, a system for using a video model for medical 3D segmentation includes one or more processors and a memory coupled to the one or more processors. The memory can store computer program instructions that, when executed by the one or more processors, perform a computer-implemented method. The method includes dividing 3D medical image data into a plurality of 2D images (e.g., 16 or more 2D images); generating a temporal sequence of the plurality of 2D images; processing the temporal sequence of the plurality of 2D images using one or more models trained to process videos, the one or more models outputting segmentation information of anatomical structures in the plurality of 2D images; and storing the segmentation information in a datastore.

In a third example implementation, a system for training a video model for medical 3D segmentation includes one or more processors and a memory coupled to the one or more processors. The memory can store computer program instructions that, when executed by the one or more processors, perform a computer-implemented method. The method includes obtaining a model pre-trained on a general video dataset; generating a training dataset that includes medical context information by dividing each 3D medical image data item of a plurality of 3D medical image data items into a set of 2D images and, for each set of 2D images, generating a temporal sequence of the set of 2D images; performing further training of the model using the temporal sequence of the set of 2D images from one or more of the 3D medical image data items, the model being trained to perform segmentation of temporal sequences of 2D images generated from 2D medical image data; and storing the trained model in a datastore.

In a fourth example implementation, a non-transitory computer-readable storage medium with instructions stored thereon includes instructions, when executed by one or more processors, that perform a computer-implemented method. The method includes dividing 3D medical image data into a plurality of 2D images; generating a temporal sequence of the plurality of 2D images; processing the temporal sequence of the plurality of 2D images using one or more models trained to process videos, the one or more models outputting segmentation information of anatomical structures in the plurality of 2D images; and storing the segmentation information in a datastore.

In a fifth example implementation, a non-transitory computer-readable storage medium with instructions stored thereon includes instructions, when executed by one or more processors, that perform a computer-implemented method. The method includes obtaining a model pre-trained on a general video dataset; generating a training dataset that includes medical context information by dividing each 3D medical image data item of a plurality of 3D medical image data items into a set of 2D images and, for each set of 2D images, generating a temporal sequence of the set of 2D images; performing further training of the model using the temporal sequence of the set of 2D images from one or more of the 3D medical image data items, the model being trained to perform segmentation of temporal sequences of 2D images generated from 2D medical image data; and storing the trained model in a datastore.

In a sixth example implementation, a system for using a video model for medical 3D segmentation includes a first computing device configured to divide 3D medical image data into one or more two-dimensional (2D) images; generate a temporal sequence of the plurality of 2D images; and process the temporal sequence of the plurality of 2D images using one or more models trained to process videos, the one or more models outputting segmentation information of anatomical structures in the plurality of 2D images. The first computing device can be further configured to transmit the segmentation information to a second computing device configured to present the segmentation information on a display.

In a seventh example implementation, a system for training a model for medical 3D segmentation includes a first computing device configured to generate a training dataset that includes medical context information, by dividing each 3D medical image data item of one or more 3D medical image data items into a set of 2D images and, for each set of 2D images, generating a temporal sequence of the set of 2D images; and transmit the training dataset to a second computing device. The second computing device may be configured to obtain a model pre-trained on a video dataset that lacks medical context information; obtain the training dataset from the first computing device; perform further training of the model using the temporal sequence of the set of 2D images from one or more of the 3D medical image data items, the model being trained to perform segmentation of temporal sequences of 2D images generated from 2D medical image data; and store the trained model in a datastore.

In an eighth example implementation, a method for training and using a video model for medical 3D segmentation includes: obtaining a model pre-trained on a general video dataset; generating a training dataset comprising medical context information by dividing each 3D medical image data item of one or more 3D medical image data items into a first set of 2D images and, for each first set of 2D images, generating a temporal sequence of the first set of 2D images; performing further training of the model using the temporal sequence of the first set of 2D images from one or more of the 3D medical image data items, the model being trained to perform segmentation of temporal sequences of 2D images generated from 2D medical image data; dividing input 3D medical image data into a second set of 2D images; generating a temporal sequence of the second set of 2D images; processing the temporal sequence of the second set of 2D images using the models, the model outputting segmentation information of anatomical structures in the second set of 2D images; and storing the segmentation information in a datastore.

### BRIEF DESCRIPTION OF THE DRAWINGS

Aspects and embodiments of the present disclosure will be understood more fully from the detailed description given below and from the accompanying drawings of various aspects and embodiments of the disclosure, which, however, should not be taken to limit the disclosure to the specific aspects or embodiments, but are for explanation and understanding only.

FIG. 1 illustrates a flow diagram of an example data flow for detecting, predicting, diagnosing, and reporting on oral conditions and/or oral health problems, in accordance with some embodiments of the present disclosure.

FIG. 2 illustrates a schematic block diagram of an example system for training and using a video transformer model for medical 3D segmentation, in accordance with some embodiments of the present disclosure.

FIG. 3 illustrates a flow diagram of an example data flow for training a video transformer model for medical 3D segmentation, in accordance with some embodiments of the present disclosure.

FIG. 4 illustrates a flow diagram of an example data flow for using a video transformer model for medical 3D segmentation, in accordance with some embodiments of the present disclosure.

FIG. 5 illustrates a flow diagram of an example method for training a video transformer model for medical 3D segmentation, in accordance with some embodiments of the present disclosure.

FIG. 6 illustrates a flow diagram of an example method for using a video transformer model for medical 3D segmentation, in accordance with some embodiments of the present disclosure.

FIGS. 7A-C illustrate flow diagrams of example data flows for training video transformer models for medical 3D segmentation during a training process, in accordance with some embodiments of the present disclosure.

FIGS. 8A-D illustrate example 2D medical image data and corresponding visual overlays of segmentation information, in accordance with some embodiments of the present disclosure.

FIG. 9 depicts a block diagram of an example processing device operating in accordance with one or more embodiments of the present disclosure.

### DETAILED DESCRIPTION

Dental treatment can refer to treating a patient's teeth and other oral anatomy to achieve desired dental outcomes, including straightening teeth, correcting bite problems, closing gaps between teeth, aligning teeth and other oral anatomy, or restorative treatments. Such dental treatments often include the patient's use of dental appliances-including aligners, retainers, braces, and other components-to shift the positions of a patient's oral anatomy. Some dental treatments can occur over several months or even years.

Medical 3D segmentation refers to partitioning a 3D image, surface (e.g., 3D point cloud), model, volume, etc. into multiple meaningful regions or objects, for example, to simplify the representation of an image, making it more efficient to analyze and extract useful information. In regard to dental treatment, a segmentation of one or more of the patient's oral anatomical structures (e.g., teeth, gingiva, etc.) may be used for a variety of purposes, including generating a dental treatment plan, generating manufacturing data in order to produce a dental appliance, displaying a visual representation of the segmentation to a dental professional, and other dental purposes. However, conventional methods for segmenting images or scans of a patient's oral anatomical structures require significant time and computing resources. For example, training a convolutional neural network (CNN) for segmentation tasks requires a large amount of labeled medical data to train the CNN. Furthermore, conventional segmentation techniques are often specialized and lack generalizability across new classes of oral anatomical structures. Because of this, conventional techniques for segmentation are often inaccurate when encountering classes of oral anatomy a CNN was not trained on. Additionally, a large amount of resources are generally required to perform 3D segmentation.

Aspects and implementations of the present disclosure address the above and other challenges by providing systems and methods for training and using artificial intelligence (AI) models that are trained on temporal sequences of 2D images, such as video transformer models (which may process temporal sequences of 2D images), for medical three-dimensional (3D) segmentation. Training such an AI model such as a video transformer model for medical 3D segmentation may include obtaining a model pre-trained on a general video dataset. The general video dataset may include video data depicting a wide variety of objects, events, etc. The general video dataset may not be limited to a medical field, and may not even include medical images in embodiments. In embodiments, the AI model may include one or more video transformer models. The systems and methods described herein may generate a training dataset for the model, and the training dataset may include medical context information. Generating this training dataset can include dividing 3D medical image data (e.g., 3D scans, images, surfaces, models, volumes, etc.) into sets of two-dimensional (2D) images and, for each set of 2D images, generating a temporal sequence of the set of 2D images. The systems and methods can perform further training of the model using the temporal sequence of the sets of 2D images. This training trains the model to perform segmentation of temporal sequences of 2D images generated from 2D medical data. The trained model can then be stored in a datastore.

Once an AI model (e.g., transformer model) has been trained to perform segmentation of temporal sequences of sliced up 3D medical image data, it may be used in production. Using the trained AI model (e.g., video transformer model) can include dividing 3D medical image data into one or more two-dimensional (2D) images. For example, the 3D medical image data may be divided into 2D slices through a 3D volume of the 3D image data. The 3D medical image data can be, for example, cone beam computed tomography (CBCT) scan data, magnetic resonance imaging (MRI) scan data, computed tomography (CT) scan data, or some other type of 3D medical image data. The 2D images may be organized into a temporal sequence. The temporal sequence may be a sequence of images that is presented one at a time in a sequence. For example, a first 2D image in the temporal sequence may be a frontmost slice of the 3D image data, and the temporal sequence may include each subsequence slice from front to back in series. In another example, a first 2D image in the temporal sequence may be a backmost slice of the 3D image data, and the temporal sequence may include each subsequence slice from back to front in series. The systems and methods may process the temporal sequence of 2D images using one or more trained models (e.g., the model trained using the training process discussed above). The one or more models can output segmentation information of anatomical structures in the 2D images. The segmentation information can be stored in a datastore, output to a display, transmitted to a remote device for display and/or storage thereon, and so on. The segmentation information can then be used for one or more dental purposes, such as performing treatment planning, producing dental appliances, and so on. Using the trained AI model (e.g., video transformer model) can also include using few-shot prompting to expand the classes of oral anatomical structures identified by the AI model.

Embodiments described herein provide significant advantages with respect to segmenting 3D medical image data. Such embodiments can use one or more AI models trained on sequences of 2D images (e.g., video transformer models) pre-trained on large-scale natural video datasets and then further trained on medical imaging data, which allows the AI models (e.g., video transformer models) to efficiently learn and predict anatomical structures in 3D medical image data without the need for a large medical image dataset. Furthermore, the segmentation of the models of the systems and methods described herein are highly accurate and generated more efficiently than conventional segmentation processes. Using few-shot prompting allows the models to transfer learned features to new anatomical structure classes with minimal labeled examples. Additionally, in embodiments the transformer attention mechanism of the video transformer models improves the accuracy when recognizing complex anatomical structures. Thus, the systems and methods of the described embodiments reduce the computing resources and time expended for medical image segmentation tasks.

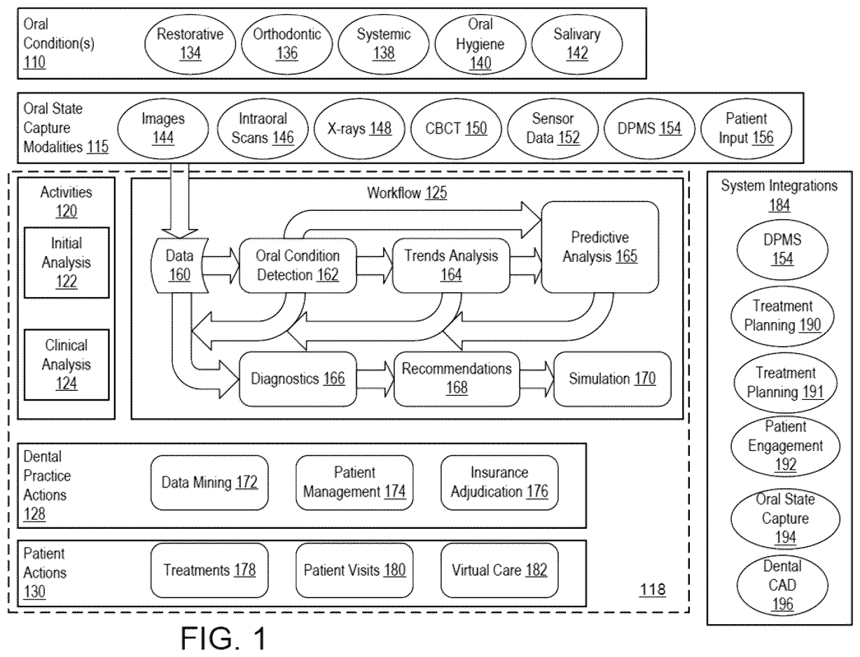

FIG. 1 illustrates a workflow 125 for detecting, predicting, diagnosing and reporting on oral conditions (e.g., oral health conditions) by an oral health diagnostics system 118, in accordance with embodiments of the present disclosure. The workflow 125 may be a general digital workflow covering use of radiographs and/or other oral state capture modalities within a digital platform of integrated products/services to provide identifications of oral conditions and/or actionable symptom recommendations and/or diagnoses of oral health problems associated with such oral conditions. The workflow 125 may be used to assist doctors and/or users of an oral health diagnostics system 118 to assess a patient's oral health, identify oral conditions, diagnose dental health problems, provide actionable symptom recommendations, provide treatment recommendations, and so on. The workflow 125 may be executed by a digital platform of integrated products that provide dental condition identifications, actionable symptom recommendations and/or diagnoses of oral health problems using analysis of data from one or more oral state capture modalities, including radiographs, CBCT scans, CT scans, and other 3D medical imaging modalities.

A patient may have one or more oral conditions 110. Oral conditions 110 may include or be related to caries, gum recession, gingival swelling, tooth wear, bleeding, malocclusion, tooth crowding, tooth spacing, plaque, tooth stains, periodontitis, bone density loss, and/or tooth cracks, for example. In some embodiments, the oral conditions 110 may include restorative conditions 134, orthodontic conditions 136, systematic conditions 138, oral hygiene conditions 140, salivary conditions 142, and so on. Restorative conditions 134 may include conditions such as caries that are addressable by performing restorative dental treatment. Such restorative dental treatment may include drilling and filling caries, performing root canals, forming preparations of teeth and applying caps or crowns to the preparations, pulling teeth, adding bridges to teeth, and so on. Restorative conditions may also include results of past restorative treatments of the patient's oral cavity. Examples of past restorations include fillings, caps, crowns, bridges, and so on. Orthodontic conditions may include conditions treatable via orthodontic treatment. Such orthodontic conditions may include a malocclusion (e.g., tooth crowding, overbite, underbite, posterior crossbite, posterior open bite, tooth gaps, etc.). Orthodontic conditions may be associated with restorative conditions in some instances. For example, tooth crowding may cause caries, which results in restorative treatment. Systematic conditions 138 may include conditions such as periodontitis, periodontal bone loss, gum recession, tooth wear, and so on. Systematic conditions 138 may be associated with restorative conditions 134 and/or orthodontic conditions 136. Oral hygiene conditions 140 may include brushing and flossing related conditions, such as development of calculus on teeth, caries, and so on. Oral hygiene conditions 140 may be related to restorative conditions 134, orthodontic conditions 136 and/or systematic conditions 138 in embodiments. Salivary conditions 142 may include a pH level of a patient's mouth that is outside of normal, a low level of saliva, and so on. Salivary conditions 142 may be related to restorative conditions 134, orthodontic conditions 136, systematic conditions 138 and/or oral hygiene conditions 140 in embodiments. For example, the detection and identification of salivary conditions may be used as an input to an ML model that can use such information to assess periodontal disease, acid reflux, vomiting, poor diet, oral cancer, and/or oropharyngeal cancer. For example, biomarkers of saliva may be used to assist in the assessment and/or management of periodontal disease. Tooth erosion, caries and/or saliva biomarkers may be used to identify acid reflux, vomiting and/or poor diet. In some instances, an oral condition of a patient may include a cross-classification. Such oral conditions may belong to multiple different categories of oral conditions 110. For example, caries may be a restorative condition 134, an orthodontic condition 136 and an oral hygiene condition 140.

A patient may have one or more oral health problems that may be root problems for the oral conditions and/or that may be caused by the oral conditions. In some embodiments, an oral condition also constitutes an oral health problem. Examples of oral health problems include caries, periodontal disease, a tooth root issue, a cracked tooth, a broken tooth, oral cancer, a cause of bad breath, and/or a cause of a malocclusion.

A dental practice (e.g., a group practice or solo practice) may capture data about a patient's oral state using one or more oral state capture modalities 115. A common oral state capture modality used by dental practices are radiographs (i.e., x-rays) 148. There are multiple different types of x-rays that a genal practice may capture of a patient's oral cavity, including bite-wing x-rays, panoramic x-rays and periapical x-rays.

A bite-wing x-ray is a type of dental radiograph used to detect dental caries (cavities) and monitor the health of teeth and supporting bone. During a bite-wing x-ray, the patient bites down on a small tab or wing-shaped device attached to the x-ray film or sensor. This helps keep the film or sensor in place while the x-ray is taken. An x-ray machine is positioned outside the mouth to capture images of the upper and lower teeth on one side of the mouth at a time. Accordingly, a bite-wing x-ray includes upper and lower teeth of one side of a patient's mouth. In embodiments, bite-wing x-rays are useful for detecting cavities between teeth and for assessing the fit of dental fillings and crowns. Bite-wing x-rays may also be used to help in diagnosing gum disease and/or to monitor bone levels around the teeth in embodiments.

A periapical x-ray, also known as a periapical radiograph, is a type of dental x-ray that focuses on specific areas of the mouth, particularly individual teeth and the surrounding bone. During a periapical x-ray, the dentist or dental radiographer positions an x-ray machine so that it captures detailed images of one or more teeth from crown to root, as well as the surrounding bone structure and supporting tissues. Periapical x-rays may provide a comprehensive view of the entire tooth, including the root tip (apex) and the bone around the tooth's root. In embodiments, periapical x-rays may be used to help diagnose oral health problems such as tooth decay (caries), infections or abscesses at the root of a tooth, bone loss around a tooth due to periodontal (gum) disease, abnormalities in the root structure or surrounding bone, evaluation of dental trauma or injuries, and so on. Periapical x-rays may also be used to assist in assessment of the status of teeth prior to dental procedures such as root canal treatment or extraction.

A panoramic x-ray, also known as a panoramic radiograph or orthopantomogram (OPG), is a type of dental radiograph that provides a comprehensive view of the entire mouth, including the teeth, jaws, temporomandibular joints (TMJ), and surrounding structures in a single image. During a panoramic x-ray, the patient stands or sits in an upright position while an x-ray machine rotates around their head in a semi-circle. The x-ray machine captures a continuous image as it moves, creating a detailed panoramic view of the entire oral and maxillofacial region. In embodiments, a panoramic x-ray may be used to assist in evaluation of the development and position of teeth, including impacted teeth, assessing the health of the jawbone and surrounding structures, detecting cysts, tumors, or other abnormalities in the jaw or adjacent tissues, planning orthodontic treatment by assessing tooth alignment and development, evaluating the placement and condition of dental implants, and/or diagnosing temporomandibular joint (TMJ) disorders or other jaw-related issues.

Another oral state capture modality that is increasingly common in dental practices are intraoral scans 146, and three-dimensional (3D) models of dental arches (or portions thereof) based on such intraoral scans. Intraoral scans are produced by an intraoral scanning system that generally includes an intraoral scanner and a computing device connected to the intraoral scanner by a wired or wireless connection. The intraoral scanner is a handheld device equipped with one or more small cameras and/or optical sensors. The dentist or dental professional moves the intraoral scanner around the patient's mouth, capturing multiple 3D images or scans of the teeth and surrounding structures from various angles. As the intraoral scanner captures the images or scans, they may be processed and displayed on a computer screen in real-time or near real-time. The collected images or scans are stitched together to create a complete 3D digital model of the patient's teeth and oral cavity. This digital impression can be manipulated, analyzed, and shared electronically with dental laboratories or specialists as needed.

An intraoral scan application executing on the computing device of an intraoral scanning system may generate a 3D model (e.g., a virtual 3D model) of the upper and/or lower dental arches of the patient from received intraoral scan data (e.g., images/scans). To generate the 3D model(s) of the dental arches, the intraoral scan application may register and stitch together the intraoral scans generated from an intraoral scan session. In one embodiment, performing image registration includes capturing 3D data of various points of a surface in multiple intraoral scans, and registering the intraoral scans by computing transformations between the intraoral scans. The intraoral scans may then be integrated into a common reference frame by applying appropriate transformations to points of each registered intraoral scan.

In one embodiment, registration is performed for each pair of adjacent or overlapping intraoral scans. Registration algorithms may be carried out to register two adjacent intraoral scans for example, which essentially involves determination of the transformations which align one intraoral scan with the other. Registration may involve identifying multiple points in each intraoral scan (e.g., point clouds) of a pair of intraoral scans, surface fitting to the points of each intraoral scans, and using local searches around points to match points of the two adjacent intraoral scans. For example, the intraoral scan application may match points, edges, curvature features, spin-point features, etc. of one intraoral scan with the closest points, edges, curvature features, spin-point features, etc. interpolated on the surface of the other intraoral scan, and iteratively minimize the distance between matched points. Registration may be repeated for each adjacent and/or overlapping scans to obtain transformations (e.g., rotations around one to three axes and translations within one to three planes) to a common reference frame. Using the determined transformations, the intraoral scan application may integrate the multiple intraoral scans into a first 3D model of the lower dental arch and a second 3D model of the upper dental arch.

The intraoral scan data may further include one or more intraoral scans showing a relationship of the upper dental arch to the lower dental arch. These intraoral scans may be usable to determine a patient bite and/or to determine occlusal contact information for the patient. The patient bite may include determined relationships between teeth in the upper dental arch and teeth in the lower dental arch.

Oral state capture modalities 115 may additionally or alternatively include one or more types of images 144 (e.g., 2D and/or 3D images) of a patient's oral cavity. In addition to generating intraoral scans, intraoral scanning systems may additionally be used to generate color 2D images of a patient's oral cavity. These color 2D images may be registered to the intraoral scans generated by the intraoral scanning system, and may be used to add color information to 3D models of a patient's dental arches. Intraoral scanning systems may additionally or alternatively generate 2D near infrared (NIR) images, images generated using fluorescent imaging, images generated under particular wavelengths of light, and so on. Such image generation may be interleaved with 3D image or intraoral scan generation by an intraoral scanner.

Dental practices may additionally include cameras for generating 3D images of a patient's oral cavity and/or cameras for generating 2D images of a patient's oral cavity. Additionally, a patient may generate images of their own oral cavity using personal cameras, mobile devices (e.g., tablet computers or mobile phones), and so on. In some instances, patients may generate images of their oral cavity based on the instruction of an application or service such as a virtual dental care application or service. In some cases, images of a patient's oral cavity (e.g., those taken by a dental practitioner or by a patient themselves) may be taken while the patient wears a cheek retractor to retract the lips and cheeks of the patient and provide better access for dental imaging (i.e., for intraoral photography).

Some dental practices also use cone beam computed tomography (CBCT) 150 as an oral state capture modality 115. CBCT is a medical imaging technique that uses a cone-shaped X-ray beam to create detailed 3D images of the dental and maxillofacial structures. CBCT scanners may be specifically designed for imaging the head and neck region, including the teeth, jawbones, facial bones, and surrounding tissues. A CBCT machine emits a cone-shaped X-ray beam that rotates around the patient's head. A detector on the opposite side of the machine captures a sequence of X-ray images from different angles. The x-ray images are processed to reconstruct them into a detailed 3D volumetric dataset. This dataset provides a comprehensive view of the patient's oral anatomy in three dimensions. CBCT scans may facilitate accurate diagnosis of various dental and maxillofacial conditions, including impacted teeth, dental infections, bone abnormalities, and temporomandibular joint disorders. In embodiments, CBCT imaging may be used for various dental and maxillofacial applications, including implant planning, orthodontic treatment planning, endodontic evaluations, oral surgery, and periodontal assessments. In embodiments, the output of a CBCT scan consists of a series of grayscale cross-sectional images that can be reconstructed into 3D models for detailed analysis of bone structures, teeth, airways, and soft tissues. CBCT scans can be displayed in different planes, including an axial (horizontal) plane (including slices from top to bottom), a sagittal (side view) plane (including slices from left to right), and a coronal (front view) plane (including slices from front to back). Additionally, CBCT scans may be output as a 3D volume rendering, providing a complete 3D representation of a scanned area (e.g., a patient's mouth, dentition, jaw, etc. The final CBCT scan data may be stored in the DICOM (Digital Imaging and Communications in Medicine) format in some embodiments, enabling radiologists, dentists, and specialists to analyze them using advanced imaging software.

Other types of oral state capture modalities 115 that may be used to collect medical data about a patient's dentition is a CT scan and a magnetic resonance imaging (MRI) scan. MRI is a non-invasive medical imaging technique that uses strong magnetic fields and radio waves to generate detailed images of the internal structures of the body. It is particularly useful for visualizing soft tissues, such as the brain, muscles, and organs, without using ionizing radiation (like X-rays or CT scans). MRI works by aligning hydrogen atoms in the body with a magnetic field and then using radiofrequency pulses to detect their signals, which are processed into high-resolution images. The output of an MRI is a set of high-resolution cross-sectional images or 3D reconstructions of the body's internal structures. These images are typically in grayscale, where different shades represent various tissue densities and compositions. MRI scans can be displayed in different planes, including an axial (horizontal) plane (including slices from top to bottom), a sagittal (side view) plane (including slices from left to right), and a coronal (front view) plane (including slices from front to back). In embodiments, the final MRI output may be in the DICOM format, which allows medical professionals to analyze and interpret the images using specialized software.

Computed Tomography (CT) is a medical imaging technique that uses X-rays and computer processing to create detailed cross-sectional images of the body's internal structures. It is particularly useful for visualizing bones, blood vessels, and soft tissues, making it valuable in diagnosing injuries, tumors, and internal bleeding. The output of a CT scan consists of a series of grayscale cross-sectional images that represent different tissue densities. These images can be reconstructed into 3D models for better visualization. CT scans can be displayed in different planes, including an axial (horizontal) plane (including slices from top to bottom), a sagittal (side view) plane (including slices from left to right), and a coronal (front view) plane (including slices from front to back). In embodiments, the final CT output may be in the DICOM format.

For image-based oral state capture modalities, multiple depictions and views of the oral cavity and internal structures can be captured (e.g., in radiographs, intraoral scans, etc.). Examples of views include occlusal views, buccal views, lingual views, proximal-distal views, panoramic views, periapical views, bitewings views, and so on. Additionally, for 3D image-based oral state capture modalities, the 3D image data may be output as a 3D surface, a 3D volume, a series of 2D slices in one or more planes (e.g., sagittal, coronal, axial, etc.), and so on.

Oral state capture modalities 115 may additionally or alternatively include sensor data 152 from one or more worn sensors. In some instances, a patient may be prescribed a compliance device (e.g., an electronic compliance indicator), an orthodontic aligner, a palatal expander, a sleep apnea device, a night guard, a retainer, or other dental appliance to be worn by the patient. Any such dental appliance may include one or more integrated sensors, which may include force sensors, pressure sensors, pH sensors, sensors for measuring saliva bacterial content, temperature sensors, contact sensors, bio sensors, and so on. Sensor data from the sensor(s) of a dental appliance worn by a patient may be reported to oral health diagnostics system 118 in embodiments. Additionally, or alternatively, a patient may wear one or more consumer health monitoring tools or fitness tracking devices, such as a watch, ring, etc. that includes sensors for tracking patient activity, heartbeat, blood pressure, electrical heart activity (e.g., generates an electrocardiogram), breathing, sleep patterns, body temperature, and so on. Data collected by such fitness tracking devices may also be reported to the oral health diagnostics system 118 in embodiments.

Oral state capture modalities 115 may additionally or alternatively include patient input 156. Patient input may include patient complaints of pain, numbness, bleeding, swelling, clicking, etc. in one more regions of their mouth. Patient input may further include input on overall health, such as information on underlying health conditions (e.g., diabetes, high blood pressure, etc.), on patient age, and so on. Such patient input may be captured and input into an oral health diagnostics system 118 in embodiments. For example, a doctor or patient may type up notes or annotations indicating the patient input, which may be ingested by the oral health diagnostics system 118 with other oral state capture modalities 115.

In some embodiments, an oral health diagnostics system 118 may include one or more system integrations 184 with external systems, which may or may not be dental related. Such system integrations 184 may be for data to be provided to the oral health diagnostics system 118 and/or for the oral health diagnostics system 118 to provide data to the other system(s).

Dental practices generally use a dental practice management system (DPMS) 154 for managing the dental practices. A DPMS 154 is a software solution designed to streamline and automate various administrative and clinical tasks within a dental practice. DPMS 154 are tailored for the needs of dental offices and help dentists and their staff manage patient information, appointments, billing, and other aspects of dental practice management efficiently. A DPMS 154 allows a dental practice to maintain comprehensive patient records, including demographic information, medical history, treatment plans, and clinical notes. The DPMS 154 provides a centralized database that enables dental staff to access patient information quickly and efficiently. DPMS 154 generally includes features for scheduling patient appointments, managing appointment calendars, and sending appointment reminders to patients. DPMS 154 provides tools for creating and managing treatment plans for patients, including digital charting of dental procedures, diagnoses, and treatment progress. This helps dentists and hygienists track patient care effectively and ensure continuity of treatment. DPMS 154 may help to automate billing processes, including generating invoices, processing payments, and managing insurance claims. It can also verify patient insurance coverage, estimate treatment costs, and submit claims electronically to insurance providers for faster reimbursement. DPMS 154 may generate financial reports and analytics to help dental practices track revenue, expenses, and profitability.

In embodiments, data from a DPMS 154 is used as one type of oral state capture modality 115. Oral health diagnostics system 118 may interface with a DPMS 154 to retrieve patient records for a patient, including past oral conditions of the patient, doctor notes, patient information (e.g., name, gender, age, address, etc.), and so on.

In addition to an ability to ingest data from a DPMS 154, oral health diagnostics system 118 in embodiments may be able to generate reports and/or other outputs that can be ingested by the DPMS 154. Accordingly, once the oral health diagnostics system 118 performs an assessment of a patient's oral conditions, oral health problems, treatment recommendations, etc., the oral health diagnostics system 118 may format such data into a format that can be understood by the DPMS 154. The oral health diagnostics system may then automatically add new data entries to the DPMS 154 for a patient based on an analysis of patient data from one or more oral state capture modalities 115.

As previously mentioned, the oral health diagnostics system 118 may have a system integration with one or more oral state capture systems (e.g., such as an intraoral scanner or intraoral scanning system, CBCT system, CT system, MRI system, etc.) 194, from which intraoral scans 146, images 144, 3D models, 3D volumes, and/or data from one or more oral state capture modalities may be received.

In embodiments, an output of oral health diagnostics system 118 may be provided to a dental computer aided drafting (CAD) system 196, such as Exocad® by Align Technology. The dental CAD system 196 may be used for designing dental restorations such as crowns, bridges, inlays, onlays, veneers, and dental implant restorations. The dental CAD system 196 may provide a comprehensive suite of tools and features that enable dental professionals to create precise and customized dental restorations digitally. The dental CAD system 196 may import digital impressions (e.g., 3D digital models of a patient's dental arches) captured using intraoral scanners, and may further import data on a patient's oral health from oral health diagnostics system 118. For example, the oral health diagnostics system 118 may export a report on a patient's oral health to the dental CAD system 196, which may be used together with a digital impression of the patient's dental arches to develop an appropriate restoration for the patient, for implant planning, for planning of surgery for implant placement, and so on.

In embodiments, oral health diagnostics system 118 may have a system integration 184 with a patient engagement system 192 (e.g., which may include a patient portal and/or patient application). The patient portal may be a portal to an online patient-oriented service. Similarly, the patient application may be an application (e.g., on a patient's mobile device, tablet computer, laptop computer, desktop computer, etc.) that interfaces with a patient-oriented service.

In an example, oral health diagnostics system 118 may integrate with a virtual care system. The virtual care system may provide a suite of digital tools and services designed to enhance patient care and communication between orthodontists/dentists and their patients. The virtual care system may leverage technology to facilitate remote monitoring, consultation, and treatment planning, allowing patients to receive dental care more conveniently and effectively.

In one embodiment, the patient engagement system 192 is or includes a virtual care system that may provide remote monitoring, teleconsultation, treatment planning, patient education and engagement, data management, and data analytics. With respect to remote monitoring, the virtual care system enables orthodontists and dentists to remotely monitor their patients' treatment progress (e.g., for orthodontic treatment) using advanced digital tools. This may include the use of smartphone apps, patient portals, or other software platforms that allow patients to capture and upload photos or videos of their teeth and orthodontic appliances. Such patient uploaded data may be provided to oral health diagnostics system 118 for automated assessment in embodiments. With regards to patient education and engagement, the virtual care system may provide reports, presentations, etc. generated by oral health diagnostics system 118 to patients (e.g., via a patient portal and/or application). For example, the oral health diagnostics system 118 may automatically generate informational videos, treatment progress trackers, compliance reminders, reports, presentations, and so on that are tailored to a patient's oral health, which may be provided to the patient via the patient portal and/or application.

In embodiments, oral health diagnostics system 118 may have a system integration 184 with one or more treatment planning system 190 and/or treatment management system 191 such as ClinCheck® provided by Align Technology®. For example, oral health diagnostics system 118 may have a system integration with an orthodontic treatment planning system and/or with a restorative dental treatment planning system. A treatment planning system 190 may use digital impressions and/or a report output by oral health diagnostics system 118 to plan an orthodontic treatment and/or a restorative treatment (e.g., to plan an ortho-restorative treatment). The treatment planning system 190 may plan and simulate orthodontic and/or restorative treatments. Treatment management system 191 may then receive data during treatment and determine updates to the treatment based on the treatment plan and the updated data.

In an example, an orthodontic treatment planning system may use advanced 3D imaging technology to create virtual models of patients' teeth and jaws based on digital impressions or intraoral scans. These digital models may be used to plan and simulate the entire course of orthodontic treatment, including the movement of individual teeth and the progression of treatment over time. Orthodontists can specify the desired tooth movements, treatment duration, and other parameters, taking into account a report provided by oral health diagnostics system 118, to create personalized treatment plans tailored to each patient's unique anatomy, oral health, and preferences. The orthodontic treatment planning system enables orthodontists to simulate the step-by-step progression of orthodontic treatment virtually, showing patients how their teeth will gradually move and align over the course of treatment. Orthodontists can visualize the planned tooth movements in 3D and make adjustments as needed to optimize treatment outcomes. The orthodontic treatment planning system may provide orthodontists and patients with visualizations of the predicted treatment outcomes, including before-and-after simulations that demonstrate the expected changes in tooth position and alignment, and how those changes might affect the patient's overall oral health as optionally predicted by the oral health diagnostics system 118. These visualizations help patients understand the proposed treatment plan and make informed decisions about their orthodontic care.

During treatment, updated data may be gathered about a patient's dentition, and such data (e.g., in the form of one or more oral state capture modalities 115) may be processed by the oral health diagnostics system 118, optionally in view of an already generated orthodontic treatment plan, to generate an updated report of the patient's overall oral health. The updated report may be provided by the oral health diagnostics system 118 to the orthodontic treatment planning system and/or orthodontic treatment management system to enable the orthodontic treatment planning/management system to perform informed modifications to the treatment plan. Thus, integration of the oral health diagnostics system with the orthodontic treatment planning system and/or treatment management system supports an iterative design process, allowing orthodontists to review and refine treatment plans based on patient feedback, clinical considerations, treatment progress, and automated reports output by oral health diagnostics system 118. This enables orthodontists to make adjustments to the treatment plan within the orthodontic treatment planning system and/or treatment management system and generate updated simulations to assess the impact of these changes on the final treatment outcome.

Accordingly, oral health diagnostics system 118 may perform treatment planning and/or management on its own and/or based on integration with one or more treatment planning systems for planning and/or managing orthodontic treatment, restorative treatment, and/or ortho-restorative treatment. An output of such planning may be an orthodontic treatment plan, a restorative treatment plan, and/or an ortho-restorative treatment plan. A doctor may provide one or more modifications to the generated treatment plan, and the treatment plan may be updated based on the doctor modifications.

In addition to those systems mentioned herein that oral health diagnostics system 118 may integrate with, oral health diagnostics system 118 may integrate with any system, application, etc. related to dentistry and/or orthodontics.

Oral health diagnostics system 118 may execute a workflow 125 that includes processing and analysis of data 160 from one or more oral state capture modalities 115. The workflow 125 may be roughly divided into activities 120 associated with an initial analysis 122 of a patient's oral health and operations associated with a clinical analysis 124 of the patient's oral health in some embodiments. One of more of the operations of the workflow may be performed by and/or assisted by application of artificial intelligence and/or machine learning models in embodiments. Multiple embodiments are discussed with reference to machine learning models herein. It should be understood that such embodiments may also implement other artificial intelligence systems or models, such as large language models in addition to or instead of traditional machine learning models such as artificial neural networks.

The workflow may include performing oral condition detection at block 162. To perform oral condition detection, one or more AI models may process the data 160 to segment the data into one or more teeth, bones, tissue, ligaments, muscles, etc. and into one or more oral conditions that may be associated with the one or more of the teeth, bones, tissues, ligaments, muscles, etc. The one or more AI models and/or additional logic may operate on the data and/or on outputs of other trained machine learning models and/or logic to identify specific teeth and apply tooth numbering to the teeth, identify bones, identify tooth roots, identify soft tissues, identify oral conditions, associate the oral conditions to specific teeth, determine locations on the teeth at which the oral conditions are identified, and so on. Examples of anatomical (e.g., oral) structures and conditions that may be segmented include tooth and Root Issues (e.g., impacted teeth, root fractures, and resorption), caries (e.g., early-stage cavities and decay), periodontal Disease (e.g., bone loss and gum disease evaluation), temporomandibular joint (TMJ) disorders, endodontic assessment (e.g., root canal anatomy, infections, and cysts), jaw alignment issues, bone structure, tooth positioning, and so on. Other examples of detectable issues that may be segmented include facial and jaw fractures, cysts and tumors, anatomical variations, sinusitis, nasal obstructions, polyps, an airway (e.g., for airway analysis such as sleep apnea diagnosis), cranial abnormalities, and so on.

The output of block 162 may include masks indicating pixels of input image data (e.g., radiographs, CBCT scans, 3D volumes, 3D models, 2D images, 2D slices of 3D volumes/surfaces/models, etc.) associated with particular dental conditions, indications of which teeth have detected oral conditions, masks indicating, for each tooth in the input data, which pixels represent that tooth, and so on. In some embodiments, oral condition detection 162 includes dividing 3D image data into a temporal sequence of 2D images (e.g., 2D slices), and processing of the temporal sequence of 2D images to perform segmentation thereof, and outputting segmentation information of the temporal sequence of 2D images. Oral condition detection 162 may additionally include adding the segmentation information of the temporal sequence of 2D images into the 3D image data that was divided into the temporal sequence of 2D images to generate 3D segmentation information. In embodiments, oral condition detection 162 includes performing the operations described in one or more of teh following figures. The output of block 162 may be input into one or more of block 164, block 165 and/or block 166 in embodiments.

At block 164, trends analysis may be performed based on the output of block 162 and on prior oral conditions of the patient detected at one or more previous times. Trends analysis may include comparing oral conditions at one or more previous times to current oral conditions of the patient. Based on the comparison, an amount of change of one or more of the oral conditions may be determined, a rate of change of the one or more oral conditions may be determined, and so on. Trends analysis may be performed using traditional image processing and image comparison. Additionally, or alternatively, trends analysis may be performed by inputting current and past oral conditions and/or data from one or more oral state capture modalities into one or more trained machine learning models. An output of block 164 may be provided to block 165 and/or block 166 in embodiments.

At block 165, predictive analysis may be performed on the output of block 162, on the output of block 164 and/or on prior oral conditions of the patient detected at one or more previous times. Predictive analysis may include predicting future oral conditions of the patient based on input data. Predictive analysis may be performed with or without an input of prior oral conditions. If prior oral conditions are used in addition to current oral conditions to predict future conditions, then the accuracy of the prediction may be increased in embodiments. In some embodiments, predictive analysis is performed by projecting identified trends determined from the trends analysis into the future. In some embodiments, predictive analysis is performed by inputting the current and/or past oral conditions into one or more trained machine learning models that output predictions of future dental conditions. Predictive analysis may be performed using traditional image processing and image comparison. Additionally, or alternatively, predictive analysis may be performed by inputting current and/or past oral conditions, trends and/or data from one or more oral state capture modalities into one or more trained machine learning models. In embodiments, the predictive analysis generates synthetic image data, which may include panoramic views, periapical views, bitewing views, buccal views, lingual views, occlusal views, and so on of the predicted future oral conditions. Generated synthetic image data may be in the form of synthetic radiographs, synthetic color images, synthetic 3D models, and so on. An output of block 165 may be provided to block 166 in embodiments.

At block 166, automated diagnostics of a patient's oral health may be performed based on data 160 and/or based on outputs of block 162, block 164 and/or block 165 in embodiments. In embodiments, one or more trained machine learning (ML) models and/or artificial intelligence (AI) models may process input data to perform the diagnostics. An output of the ML models and/or AI models may include actionable symptom recommendations usable to diagnose oral health problems and/or actual diagnoses of oral health problems associate with the detected oral conditions.

At block 168, based on the data 160, oral conditions identified at block 162, output of trends analysis performed at block 164, output of predictive analysis performed at block 165 and/or output of diagnostics performed at block 166, processing logic may generate one or more treatment recommendations for a patient. The treatment recommendations may include multiple different treatment options, with different probabilities of success associated with the different treatment options.

At block 170, processing logic may generate one or more treatment simulations based on one or more of the treatment recommendations. The treatment simulations may include an alternative predictive analysis that shows predicted states of oral conditions and/or oral health problems of the patient after treatment is performed, or after one or more stages of treatment are performed. Treatment simulations may include generated synthetic image data, which may be in the form of synthetic radiographs, synthetic color images, synthetic 3D models, synthetic 3D volumes, synthetic 2D images, synthetic CBCT scans, synthetic CT scans, synthetic MRI scans, and so on. The synthetic image data may show what a patient's oral cavity would look like after treatment and/or after one or more intermediate and/or final stages of a multi-stage treatment (e.g., such as orthodontic treatment or ortho-restorative treatment).

Post treatment simulations may be compared to predicted simulations of the predicted states of the oral conditions absent treatment (e.g., as determined at block 165) in embodiments.

In embodiments, a report may be generated including the data 160 and/or outputs of one or more of blocks 162, 164, 165, 166, 168 and/or 170. The report may include labeled 2D and/or 3D images, labeled 3D volumes, labeled scans, labeled 3D surfaces, a dental chart, notes, annotations, and/or other information. The report may include a dynamic presentation (e.g., a video) that shows progression of dental conditions over time in some embodiments. The report may be stored and/or exported to one or more other systems (e.g., DPMS 154, treatment planning system 190, patient engagement system 192, dental CAD system 196).

The oral health diagnostics system 118 may perform multiple dental practice actions 128 and/or patient actions 130 in addition to, or instead of, storing a generated report and/or exporting the report to other systems. Examples of dental practice actions 128 that may be performed include data mining 172, patient management 174 and/or insurance adjudication 176. Examples of patient actions 130 that may be performed include treatments 178, patient visits 180 and/or virtual care 182. One or more of the actions may be performed based on leveraging external systems in embodiments. For example, virtual care 182 may be performed based on leveraging a patient portal and/or application of a virtual dental care system. Patient visits 180 may be performed based on leveraging a DPMS 154. Treatments 178 may be performed based on leveraging a treatment planning system 190 for planning, tracking and/or management of a treatment. Patient management 174 and/or insurance adjudication 176 may be performed based on leverage of a DPMS 154.

Data mining 172 may include analysis of patient data of a dental practice in embodiments. Data mining may be performed for a single dental practice or for multiple different dental practices. Data mining may be performed to determine strengths and weaknesses of a dental practice relative to other dental practices and/or to determine strengths and weaknesses of individual doctors relative to other doctors within a dental practice and/or outside of a dental practice (e.g., in a geographic region). As a result of data mining 172, a report may be generated indicating things for a doctor to focus on, types of procedures that a doctor should perform more, oral state capture modalities that a doctor should use more frequently, and so on.

Patient management 174 for a dental practice may include a range of tasks and processes aimed at providing quality care and ensuring positive experiences for patients throughout their interactions with the dental practice. Patient management may include appointment scheduling, patient registration and check-in, medical and dental history and records management (e.g., including information about past treatments, allergies, medications, and relevant medical conditions for each patient), treatment planning and coordination, financial management and billing (e.g., including collecting payments, processing insurance claims, providing cost estimates, and discussing payment options or financing arrangements with patients), patient communication and education (e.g., providing information about treatments, procedures, and oral hygiene instructions, as well as addressing patient concerns, answering questions, and maintaining open lines of communication throughout the treatment process), follow-up and recall, and patient satisfaction and feedback management.

Insurance adjudication 176 for a dental practice refers to the process of evaluating and determining the coverage and reimbursement for dental services provided to patients by their dental insurance carriers. Insurance adjudication 176 involves submitting claims to insurance companies, reviewing the claims for accuracy and completeness, and processing them according to the terms of the patient's insurance policy. After providing dental services (e.g., treatment) to a patient, the dental practice submits a claim to the patient's insurance company electronically or via paper. The claim includes information such as the patient's demographic details, treatment provided, diagnosis codes, procedure codes (CPT or ADA codes), and any other relevant documentation. In embodiments, such documentation is automatically prepared by oral health diagnostics system 118. Upon receiving an insurance claim, the insurance company reviews the claim to determine coverage eligibility and benefits according to the terms of the patient's insurance policy. The insurance company evaluates the claim and calculates the amount of coverage and reimbursement based on the patient's benefits plan, contractual agreements with the dental office, and applicable fee schedules. The adjudication process may involve verifying the accuracy of the submitted information, applying deductibles, copayments, and coinsurance, and determining the allowed amount for each covered service. In embodiments, oral health diagnostics system 118 may automatically generate responses to inquiries from insurance companies about already submitted claims. After adjudicating a claim, the insurance company sends an Explanation of Benefits (EOB) to the dental office and the patient. The EOB outlines the details of the claim, including the services rendered, the amount covered by insurance, any patient responsibility (such as copayments or deductibles), and the reason for any denials or adjustments. If the claim is approved, the insurance company issues payment to the dental office for the covered services. The dental office then reconciles the payment received with the treatment provided and updates the patient's financial records accordingly. If there are any discrepancies or denials, the dental office may need to follow up with the insurance company to resolve issues or appeal denied claims. In embodiments, oral health diagnostics system 118 automatically handles such follow-ups. After insurance adjudication, the dental office bills the patient for any remaining balance or patient responsibility not covered by insurance, such as deductibles, copayments, or non-covered services. The patient is responsible for paying these amounts according to the terms of their insurance policy and the dental office's financial policies.

In some embodiments, the workflow 125 can be implemented with just a few clicks of a web portal or dental practice application to enable doctors to purchase and activate one or more oral health diagnostics services. When patient records (e.g., data from one or more oral state capture modalities 115, such as intraoral scans 146, virtual care images 144, digital x-rays 148, CBCT scans 150, etc.) are collected as a routine part of a dental appointment, these records may be uploaded to a digital platform of the oral health diagnostics system 118. The oral health diagnostics system 118 may start an analysis for the different oral (e.g., clinical) conditions that have been activated for the patient by the doctor, and may generate a report on the different identified oral conditions. In seconds the doctor may receive a report that has visual indications with colored clues of assessments for a number of possible dental conditions, dental health problems, and so on. As an example, the oral health diagnostics system 118 can send this data to the treatment planning system 190 or treatment management system 191 to process.

In some embodiments, the treatment planning system 190 can integrate this information with an orthodontic treatment plan. The doctor can share the analysis visually chairside with the patient and provide treatment recommendations based on the diagnosis. This can occur on the treatment planning and/or management system 190, 191 or on an application on an intraoral scanning system, CBCT system, MRI system or x-ray system, for example. The doctor can also share the analysis with the patient and send visual assessments via patient engagement system 192. Integrated education modules may provide interactive context sensitive education tools designed to help the doctor diagnose and help convert the patient to the treatment in embodiments.

Some of the analyses that are performed to assess the patient's dental health are oral health condition progression analyses that compare oral conditions of the patient at multiple different points in time. For example, one carries assessment analysis may include comparing caries at a first point in time and a second point in time to determine a change in severity of the caries between the two points in time, if any. Other time-based comparative analyses that may be performed include a time-based comparison of gum recession, a time-based comparison of tooth wear, a time-based comparison of tooth movement, a time-based comparison of tooth staining, and so on. In some embodiments, processing logic automatically selects data collected at different points in time to perform such time-based analyses. Alternatively, a user may manually select data from one or more points in time to use for performing such time-based analyses.

In one embodiment, the different types of oral conditions for which analyses are performed and that are included in the detected oral conditions include tooth cracks, gum recession, tooth wear, occlusal contacts, crowding and/or spacing of teeth and/or other malocclusions, plaque, tooth stains, calculus, bone loss, bridges, fillings, implants, crowns, impacted teeth, root-canal fillings, and caries. Additional, fewer and/or alternative oral conditions may also be analyzed and reported. In embodiments, multiple different types of analyses are performed to determine presence, location and/or severity of one or more of the oral conditions. One type of analysis that may be performed is a point-in-time analysis that identifies the presence and/or severity levels of one or more oral conditions at a particular point-in-time based on data generated at that point-in-time (e.g., at block 162). For example, a single x-ray image, CBCT scan, CT scan, MRI scan, etc. of a patient may be analyzed to determine whether, at a particular point-in-time, a patient's dental arch included any caries, gum recession, tooth wear, problem occlusion contacts, crowding, spacing or tooth gaps, plaque, tooth stains, and/or tooth cracks. Another type of analysis that may be performed is a time-based analysis that compares oral conditions at two or more points in time to determine changes in the oral conditions, progression of the oral conditions and/or rates of change of the oral conditions (e.g., at block 164). For example, in embodiments a comparative analysis is performed to determine differences between x-rays, CBCT scans, CT scans, MRI scans, etc. taken at different points in time. The differences may be measured to determine an amount of change, and the amount of change together with the times at which the intraoral scans were taken may be used to determine a rate of change. This technique may be used, for example, to identify an amount of change and/or a rate of change for tooth wear, staining, plaque, crowding, spacing, gum recession, caries development, tooth cracks, and so on.

In embodiments, one or more trained models are used to perform at least some of the one or more oral condition analyses. The trained models may include physics models and/or AI models (e.g., machine learning models), for example. In one embodiment, a single model may be used to perform multiple different analyses (e.g., to identify any combination of tooth cracks, gum recession, tooth wear, occlusal contacts, crowding and/or spacing of teeth and/or other malocclusions, plaque, tooth stains, and/or caries). Additionally, or alternatively, different models may be used to identify different oral conditions. For example, a first model may be used to identify tooth cracks, a second model may be used to identify tooth wear, a third model may be used to identify gum recession, a fourth model may be used to identify problem occlusal contacts, a fifth model may be used to identify crowding and/or spacing of teeth and/or other malocclusions, a sixth model may be used to identify plaque, a sixth model may be used to identify tooth stains, and/or a seventh model may be used to identify caries.

In one embodiment, at block 162 intraoral data from one or more points in time are input into one or more trained machine learning models that have been trained to receive the intraoral data as an input and to output classifications of one or more types of oral conditions. In one embodiment, the trained machine learning model(s) is trained to identify areas of interest (AOIs) from the input intraoral data and to classify the AOIs based on oral conditions. The AOIs may be or include regions associated with particular oral conditions. The regions may include nearby or adjacent pixels or points that satisfy some criteria, for example. The intraoral data that is input into the one or more trained machine learning model may include three-dimensional (3D) data and/or two-dimensional (2D) data. The intraoral data may include, for example, one or more 3D models of a dental arch, one or more projections of one or more 3D models of a dental arch onto one or more planes (optionally comprising height maps), one or more x-rays of teeth, one or more CBCT scans, a panoramic x-ray, near-infrared and/or infrared imaging data, color image(s), ultraviolet imaging data, intraoral scans, one or more bitewing x-rays, one or more periapical x-rays, and so on. In some embodiments, a temporal sequence of 2D images generated from 3D data is input into the one or more AI models. If data from multiple imaging modalities are used (e.g., panoramic x-rays, bitewing x-rays, periapical x-rays, CBCT scans, 3D scan data, color images, and NIRI imaging data), then the data may be registered and/or stitched together so that the data is in a common reference frame and objects in the data are correctly positioned and oriented relative to objects in other data.

The trained AI model(s) may output segmentation information in embodiments. Segmentation information may be output for individual 2D images in a temporal sequence of 2D images generated from 3D data, and/or may be output for the 3D data from which the temporal sequence of 2D images was generated. In some embodiments, one or more AI models output a probability map, where each point in the probability map corresponds to a point in the intraoral data (e.g., a pixel in an intraoral image or point on a 3D surface) and indicates probabilities that the point represents one or more dental classes. In one embodiment, a single model outputs probabilities associated with multiple different types of dental classes, which includes one or more oral health condition classes. In an example, a trained machine learning model may output a probability map with probability values for a teeth dental class and a gums dental class. The probability map may further include probability values for tooth cracks, gum recession, tooth wear, occlusal contacts, crowding and/or spacing of teeth and/or other malocclusions, plaque, tooth stains, healthy area (e.g., healthy tooth and/or healthy gum) and/or caries. In the case of a single machine learning model that can identify each of tooth cracks, gum recession, tooth wear, occlusal contacts, crowding and/or spacing of teeth and/or other malocclusions, plaque, tooth stains, and caries, eleven valued labels may be generated for each pixel, one for each of teeth, gums, healthy area, tooth cracks, gum recession, tooth wear, occlusal contacts, crowding and/or spacing of teeth and/or other malocclusions, plaque, tooth stains, and caries. In some embodiments, the corresponding predictions have a probability nature: for each pixel there are multiple numbers that may sum up to 1.0 and can be interpreted as probabilities of the pixel to correspond to these classes. In one embodiment, the first two values for teeth and gums sum up to 1.0 and the remaining values for healthy area, tooth cracks, gum recession, tooth wear, occlusal contacts, crowding and/or spacing of teeth and/or other malocclusions, plaque, tooth stains, and/or caries sum up to 1.0.

In some instances, multiple machine learning models are used, where each machine learning model identifies a subset of the possible oral conditions. For example, a first trained machine learning model may be trained to output a probability map with three values, one each for healthy teeth, gums, and caries. Alternatively, the first trained machine learning model may be trained to output a probability map with two values, one each for healthy teeth and caries. A second trained machine learning model may be trained to output a probability map with three values (one each for healthy teeth, gums and tooth cracks) or two values (one each for healthy teeth and tooth cracks). One or more additional trained machine learning models may each be trained to output probability maps associated with identifying specific types of oral conditions.

In embodiments, image processing and/or 3D data processing may be performed on radiographs, CBCT scan data, CT scan data, MRI scan data and/or other dental data. Such image processing and/or 3D data processing may be performed using one or more algorithms, which may be generic to multiple types of oral conditions or may be specific to particular oral conditions. For example, a trained model may identify regions on a dental radiograph or CBCT scan that include caries, and image processing may be performed to assess the size and/or severity of the identified caries. The image processing may include performing automated measurements such as size measurements, distance measurements, amount of change measurements, rate of change measurements, ratios, percentages, and so on. Accordingly, the image processing and/or 3D data processing may be performed to determine severity levels of oral conditions identified by the trained model(s). Alternatively, the trained models may be trained both to classify regions as caries and to identify a severity and/or size of the caries.

The one or more trained machine learning models that are used to identify, classify and/or determine a severity level for oral conditions may be neural networks such as deep neural networks or convolutional neural networks. Such machine learning models may be trained using supervised training in embodiments.

A dentist, after a quick glance at the dental diagnostics summary, may determine that a patient has carries, clinically significant tooth wear, and crowding/spacing and/or other malocclusions and/or oral conditions.

In embodiments, the oral health diagnostics system, and in particular the dental diagnostics summary, helps a doctor to quickly detect oral conditions (e.g., oral health conditions) and/or oral health problems and their respective severity levels, helps the doctor to make better judgments about treatment of oral conditions and/or oral health problems, and further helps the doctor in communicating with a patient that patient's oral conditions and/or oral health problems and possible treatments. This makes the process of identifying, diagnosing, and treating oral conditions and/or oral health problems easier and more efficient. The doctor may select any of the oral conditions and/or oral health problems to determine prognosis of that condition as it exists in the present and how it will likely progress into the future. Additionally, the oral health diagnostics system may provide treatment simulations of how the oral conditions and/or oral health problems will be affected or eliminated by one or more treatments.

In embodiments, a doctor may customize the oral conditions, oral health problems and/or areas of interest by adding emphasis or notes to specific oral conditions, oral health problems and/or areas of interest. For example, a patient may complain of a particular tooth aching. The doctor may highlight that particular tooth on a radiograph. Oral conditions that are found that are associated with the particular highlighted or selected tooth may then be shown in the dental diagnostics summary. In a further example, a doctor may select a particular tooth (e.g., lower left molar), and the dental diagnostics summary may be updated by modifying the severity results to be specific for that selected tooth. For example, if for the selected tooth an issue was found for caries and a possible issue was found for tooth stains, then the dental diagnostics summary would be updated to show no issues found for tooth wear, occlusion, crowding/spacing, plaque, tooth cracks, and gum recession, to show a potential issue found for tooth stains and to show an issue found for caries. This may help a doctor to quickly identify possible root causes for the pain that the patient complained of for the specific tooth that was selected. The doctor may then select a different tooth to get a summary of dental issues for that other tooth.

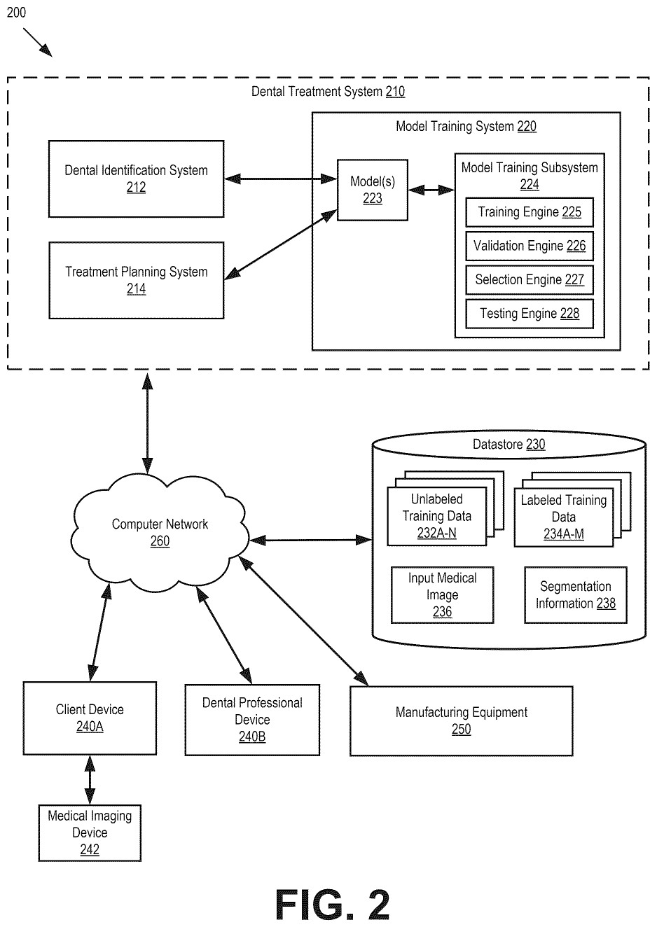

FIG. 2 is a schematic block diagram illustrating an example system 200 (e.g., an example system architecture) for training and using an AI model (e.g., a video transformer model) for medical 3D segmentation, in accordance with some embodiments of the present disclosure. The system 200 may include a dental treatment system 210, a datastore 230, one or more user devices 240, manufacturing equipment 250, and/or a computer network 260. The dental treatment system 210 may include a dental identification system 112, a treatment planning system 114, and/or a model training system 220. The model training system 220 may include one or more models 223 and/or a model training subsystem 224 (which may include various components for training the one or more models 223).

The dental treatment system 210 may include one or more computing devices. A computing device may include a rackmount server, a router computer, a server computer, a personal computer, a mainframe computer, a laptop computer, a tablet computer, a desktop computer, a graphics processing unit (GPU), an accelerator application-specific integrated circuit (ASIC) (e.g., a Tensor Processing Unit (TPU)), etc. One or more operations of the dental treatment system 210 may be performed by a cloud computing service, cloud data storage service, etc. Components of the dental treatment system 210 may include or be executed by one or more computing devices of the dental treatment system 210.

In one embodiment, the dental identification system 212 may perform segmentation of medical image data provided to the dental identification system 212 as input. The dental identification system 212 may use one or more models 223 to perform the segmentation. The one or more trained models 223 may include one or more AI models trained and/or otherwise programmed to segment medical image data. The dental identification system 212 may output segmentation information for the input medical image. The segmentation information can then be used, for example, by the treatment planning system 214 or the dental professional device 240B.

In some embodiments, the treatment planning system 214 may include one or more components that plan a dental treatment for a patient. A dental treatment plan may include a plan for multi-stage orthodontic treatment. The dental treatment plan may include a plan for straightening a patient's teeth, correcting bite problems experienced by the patient, closing gaps between the patient's teeth, or aligning the patient's teeth and other oral anatomy of the patient, for example. A dental treatment plan may include a restorative dental treatment. Examples of such restorative treatments include crowns, veneers, bridges, composite bonding, extractions, fillings, and so on. For example, a restorative treatment may include replacing an old crown with a new crown. A dental treatment plan may include disposing one or more dental appliances or hardware on the oral anatomy of the patient to achieve one or more dental outcomes. The treatment planning system 214 may receive treatment instruction data provided by the dental professional device 240B and use the dental instruction data to generate a dental treatment plan for a patient. In some embodiments, the treatment planning system 214 may use one or more models 223 to assist in generating the dental treatment plan. The one or more models 223 may include one or more AI models trained and/or otherwise programmed to assist in generating a dental treatment plan.

In some embodiments, the various AI models discussed in connection with the models 223 (e.g., a supervised machine learning model, an unsupervised machine learning model, etc.) may be combined in one model (e.g., a hierarchical model) or may be separate models. Data may be passed back and forth between several distinct models included in the model(s) 223 and the dental identification system 212 or treatment planning system 214, or the data may be provided to a single model 223 multiple times. In some embodiments, some or all of these operations may, instead, be performed by a different device, e.g., a server device (not shown in FIG. 1) of the dental treatment system 210, a client device 240, or some other computing device. It will be understood by one of ordinary skill in the art that variations in data flow, which components perform which processes, which models are provided with which data, and the like are within the scope of this disclosure.

In one or more embodiments of the present disclosure, AI models may perform many tasks, including segmenting medical image data, generating a dental treatment plan, splitting an input up into related sections, formatting input text, detecting subject matter, transforming natural language instructions into machine-readable instructions, performing clinical checking, or the like. The model(s) 223 may be trained using one or more training datasets. AI models may include machine learning models or other types of AI models.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output. A graph convolutional network (GCN) is a type of machine learning model that is designed to operate on graph-structured data. Graph data includes nodes and edges connecting various nodes. GCNs extend CNNs to be applicable to graph-structured data which captures relationships between various data points. GCNs may be particularly applicable to meshes, such as three-dimensional data.

Many other types and varieties of machine learning models may be utilized for one or more embodiments of the present disclosure. Further types of machine learning models that may be utilized for one or more aspects include transformer-based architectures, generative adversarial networks, volumetric CNNs, etc. Selection of a specific type of machine learning model may be performed responsive to an intended input and/or output data, such as selecting a model adapted to segment medical image data, generate dental treatment plans, etc.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

The model(s) 223 may include a large language model (LLM) configured via prompt engineering to perform one or more tasks based on treatment provider input. An LLM is a type of AI model designed to understand and generate human-like text, natural language, or the like. LLMs are generally built using deep learning techniques and trained on large datasets from diverse sources. LLMs often provide natural language understanding, text generation, contextual learning, instruction following based on nuanced or detailed prompts, and other functions. LLMs have advantages based on a large extent of knowledge mapped by the layers of the models, as well as an ability to make correct connections between concepts to generate relevant output. In some embodiments, an LLM may represent a single general-purpose or specifically trained or adjusted LLM, which may be utilized multiple times using different engineered prompts to perform various tasks in association with a set of doctor protocol description, instructions, input, etc.

A model 223 may include a video transformer. A video transformer may include an AI model that uses a transformer architecture to process or analyze video data to capture spatial and temporal relationships in the video data. A video transformer may include an encoder-decoder architecture that includes one or more self-attention mechanisms and/or one or more feed-forward mechanisms. In some embodiments, the video transformer can include an encoder that can encode input video data into a vector space representation and a decoder that can reconstruct the data from the vector space, generating an output that seeks to reconstruct the input video data. The self-attention mechanism can compute the importance of visual data within an image with respect to all of the input video data.

In one embodiment, the dental treatment system 210 may include a model training system 220. The model training system 220 may include the one or more models 223 and a model training subsystem 224 used to train the one or more models 223. The model training subsystem 224 may include one or more components that train AI models. The model training subsystem 224 may include a training engine 225, a validation engine 226, a selection engine 227, and/or a testing engine 228. An engine (e.g., a training engine 225, a validation engine 226, a selection engine 227, and/or a testing engine 228) may refer to hardware (e.g., circuitry, dedicated logic, programmable logic, microcode, processing device, etc.), software (such as instructions run on a processing device, a general-purpose computer system, or a dedicated machine), firmware, microcode, or a combination thereof. The training engine 225 may be capable of training an AI model (e.g., one or more of the models 223) using one or more sets of features associated with a training set from a data set generator. The training engine 225 may generate multiple trained AI models, where each trained AI model corresponds to a distinct set of features of a training set. For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. The data set generator may receive the output of a trained AI model, collect that data into training, validation, and testing data sets, and use the data sets to train a second model.

The training engine 225 may use different training datasets to train different models 223. For example, the training engine 225 may use a generated video dataset and medical context information to train a segmentation model. The training engine may use instruction data from a specific subset of treatment categories, such as disorder types, treatment types, disorder severities, or another categorization to train a treatment model.

The validation engine 226 may be capable of validating a trained AI model using a corresponding set of features of a validation set from the data set generator. For example, a first trained AI model that was trained using a first set of features of the training dataset may be validated using the first set of features of the validation set. The validation engine 226 may determine an accuracy of each of the trained AI models based on the corresponding sets of features of the validation set. The validation engine 226 may discard trained AI models that have an accuracy that does not meet a threshold accuracy. In some embodiments, the selection engine 227 may be capable of selecting one or more trained AI models that have an accuracy that meets a threshold accuracy. In some embodiments, the selection engine 227 may be capable of selecting the trained AI model that has the highest accuracy of the trained AI models.

The testing engine 228 may be capable of testing a trained AI model using a corresponding set of features of a testing set from the data set generator. For example, a first trained AI model that was trained using a first set of features of the training set may be tested using the first set of features of the testing set. The testing engine 228 may determine a trained AI model that has the highest accuracy of all of the trained AI models based on the testing sets.

In the case of an AI model, the AI model may refer to the model artifact that is created by the training engine 225 using a training set that includes data inputs and corresponding target outputs (correct answers for respective training inputs). Patterns in the data sets can be found that map the data input to the target output (the correct answer), and the AI model is provided mappings that capture these patterns. The AI model may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network, CNN, graph neural network, GCN), transformers, etc.

In some embodiments, the datastore 230 may be a memory (e.g., random access memory), a drive (e.g., a hard drive, a flash drive), a database system, a cloud-accessible memory system, or another type of component or device capable of storing data. The datastore 230 may include multiple storage components (e.g., multiple drives or multiple databases) that may span multiple computing devices (e.g., multiple server computers). The datastore 230 may store various types of data, including unlabeled training data 232A-N, labeled training data 234A-M, an input medical image 236, and/or segmentation information 238.

The unlabeled training data 232A-N may include one or more sets of video data. In one embodiment, a first set of unlabeled training data 232A may include a general video dataset. The general video dataset may include video data depicting a wide variety of objects, events, etc. The general video dataset may include one or more videos that lack medical context information (e.g., the videos may be free of or may contain very few depictions of medical objects, images, scans, etc.). The general video dataset may provide a foundation for a video transformer model, which can then undergo further training on one or more datasets specific to medical images. The general video dataset may include a sequence of video frames that have been divided into multiple image patches. In the sequence of patches, the patches belonging to the temporal first frame of the video may appear first, the patches belonging to the temporal second frame may appear next, the patches belonging to the temporal third frame may appear next, and so on. For each set of patches belonging to a certain frame, the patches may be ordered spatially. For example, the patches may be ordered from top-left to bottom-right or some other spatial ordering.

In some embodiments, a second set of unlabeled training data 232B may include a 3D medical image dataset. The 3D medical image dataset may include one or more 3D medical images, and each 3D medical image may be divided into a set of 2D images. For example, the 3D medical image may first be divided depth-wise into a sequence of multiple 2D images, and each 2D image may then be divided into sets of patches. In the sequence of patches, the patches belonging to the front layer of the 3D image may appear first, the patches belonging to the layer behind the front layer may appear next, and so on. For each set of patches belonging to a certain layer, the patches may be ordered spatially. For example, the patches may be ordered from top-left to bottom-right or in some other spatial ordering.

The labeled training data 234A-M may include one or more sets of 3D medical image data labeled with ground truth data. In one embodiment, a first set of labeled training data 234A may include dataset items, and each item may include an input 3D medical image and a corresponding ground truth segmentation mask. Each pixel in the ground truth mask may be labeled with a class, indicating which class of anatomical structures it belongs to. In embodiments, the labeled training data 234A-M is a much smaller dataset than the unlabeled training data 232A-N. In embodiments, one or more AI models may be trained to perform segmentation of a temporal sequence of images generated from 3D medical image data using few shot learning.

The input medical image 236 may include 3D medical image data. The input medical image 236 may include a medical imaging scan performed by a medical imaging device (e.g., the medical imaging device 242, discussed below). The client device 240A may obtain the medical imaging scan from the medical imaging device 242 and provide the medical imaging scan to the datastore 230 to be stored as the input medical image 236. The input medical image 236 may include CBCT scan data, MRI scan data, CT scan data, or another type of medical imaging data. The segmentation information 238 may include segmentation data generated by the dental identification system 212 based on the input medical image 236. For example, a model 223 trained and/or programmed to segment medical imaging data may use the input medical image 236 as input and may generate the segmentation information 238 as output. In one embodiment, the segmentation information 238 may include a segmentation mask, which may include data indicating, for each pixel in an image (e.g., the input medical image 236), which anatomical structure class the pixel belongs to. The segmentation information 238 may indicate semantic segmentation or instance segmentation. In embodiments, the model(s) output segmentation masks of individual 2D images in a temporal sequence of 2D images generated from 3D medical image data. The segmentation masks of the individual 2D images may then be combined in embodiments to form a 3D segmentation mask for the 3D medical image data in embodiments.

In some embodiments, the datastore 230 may store treatment planning data. The treatment planning data may be or include machine readable instructions or other data, e.g., related to target positions of one or more teeth to treat orthodontic disorders, related to treatment operations or steps for treating dental disorders, or the like. The treatment planning system may generate the treatment planning data based on treatment instruction data. In one embodiment, the treatment instruction data may include instructions related to one or more treatment plans or treatment protocols. The treatment instruction data may include dental professional comments, notes, or instructions related to treatment plans or treatment protocols. The treatment instruction data may relate to natural language input by one or more dental professionals, doctors, orthodontists, healthcare professionals, treatment providers, practitioners, etc. The treatment instruction data may include dental treatment plan manipulation data, which may include data that the treatment planning component may use to set up or modify a dental treatment plan for a patient. In some embodiments, the treatment planning system 214 may obtain treatment instruction data, use at least some of the treatment instruction data as input to a treatment model 223, and obtain outputs indicative of treatment plan data and/or treatment protocol data, which the treatment planning system 214 may store in the datastore 230. The datastore 230 may store treatment protocol data, which may include data related to general plans meant to relate to one or more generic, common, repeatedly encountered, or the like healthcare disorders (e.g., dental disorders, malocclusion, misalignment, or the like). In some embodiments, the treatment planning system 214 may generate the treatment planning data and/or the treatment protocol data using unsupervised machine learning (e.g., the treatment planning data and/or the treatment protocol data can include output from a treatment model 123 that was trained using unlabeled data). In some embodiments, the treatment planning system 214 may generate the treatment planning data and/or the treatment protocol data using semi-supervised learning (e.g., training data may include a mix of labeled and unlabeled data, etc.).

In some embodiments, the client devices 240A-B may each include one or more computing devices. The client device 240A may include a device configured to obtain one or more medical imaging scans of one or more anatomical structures of a patient from a medical imaging device 242. The medical imaging device 242 may include one or more imaging devices such as a CBCT scanner, an MRI machine, a CT scanner, or some other type of medical imaging device that captures scans of a patient's anatomical structures from different angles and/or positions. The client device 240A may obtain the one or more scans of the patient's anatomy and may generate 3D medical imaging data based on the scans, or the client device 240A may provide the one or more scans to another computing device (e.g., a computing device of the dental treatment system 210) configured to generate the 3D medical imaging data based on the scans. The 3D medical imaging data may be stored in the datastore 230 as part of the input medical image 236.

In one embodiment, an anatomical structure may include one or more oral anatomical structures. An oral anatomical structure may include a component of a patient's oral anatomy. For example, an oral anatomical structure may include a tooth, a tooth type, a nerve, a bone, a sinus, gingiva, or other anatomical structures.

In one embodiment, the dental professional device 240B may include a computing device used by a dental professional to view the input medical image 236 and the segmentation information 238 generated from the input medical image 236. The dental professional may view the segmentation information 238 and use the dental professional device 240B to generate treatment instruction data based on the segmentation information 238. The dental professional device 240B may capture the treatment instruction data input by the dental professional. The treatment instruction data may be provided via a graphical user interface (UI) of the dental professional device 240B. The treatment instruction data may relate to one or more dental treatment plans, treatment protocols, or the like regarding a patient. Treatment instruction data may relate to specific cases, e.g., dental treatment plans for a particular patient. In some embodiments, the dental professional device 240B may be used by a dental professional to view or manipulate a dental treatment plan of a patient, submit prescriptions, or perform other dental treatment operations. The dental professional device 240B may receive treatment planning data or treatment protocol data generated by the treatment planning system 214 and may display a visual representation of such data in order to obtain information about the dental treatment plan of a patient.

In one embodiment, the manufacturing equipment 250 may include one or more devices that manufacture appliances for performing treatment of a dental treatment plan. An appliance may include hardware or other devices that can be used to adjust tooth positions or other oral anatomy of a patient. The treatment planning system 214 may generate manufacturing data based on the treatment planning data or the treatment protocol data, and the manufacturing data may be used for fabricating one or more appliances. Manufacturing operations may be initiated in response to the manufacturing equipment receiving the manufacturing data.

In some embodiments, the computer network 260 may include a public network or private network that provides access and data communication between one or more components of the system 100 and publicly and/or privately available computing devices. The computer network 260 may include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the functions of the dental treatment system 210 may be provided by a fewer number of machines. For example, in some embodiments, the dental identification system 212, the treatment planning system 214, the model training system 220, and/or the datastore 230 may be integrated into a single machine or system. In some embodiments the dental identification system 212, the treatment planning system 214, the model training system 220, the datastore 230, the client device 240A, and/or the dental professional device 240B may be integrated into a single machine or system. In some embodiments, functions of the dental treatment system 210, the datastore 230, the client device 240A, and/or the dental professional device 240B may be performed by a cloud-based service.

In general, functions described in one embodiment as being performed by the dental identification system 212 can also be performed by the treatment planning system 214 in other embodiments, if appropriate. Some functions described as being performed by the dental identification system 212 can also be performed by a computing device external from the dental treatment system 210 (e.g., the client device 240A, the dental professional device 240B, or a remote computing device in data communication with the system 200 via the computer network 260). In addition, the functionality attributed to a particular component can be performed by different or multiple components operating together. In addition, the functions of a particular component can be performed by different or multiple components operating together. The dental identification system 212 or treatment planning system 214 may be accessed as a service provided to other systems or devices through appropriate application programming interfaces (API). In some embodiments, a “user” may be represented as a single individual. However, other embodiments of the disclosure encompass a “user” being an entity controlled by a plurality of users and/or an automated source. For example, a set of individual users federated as a group of administrators may be considered a “user.”

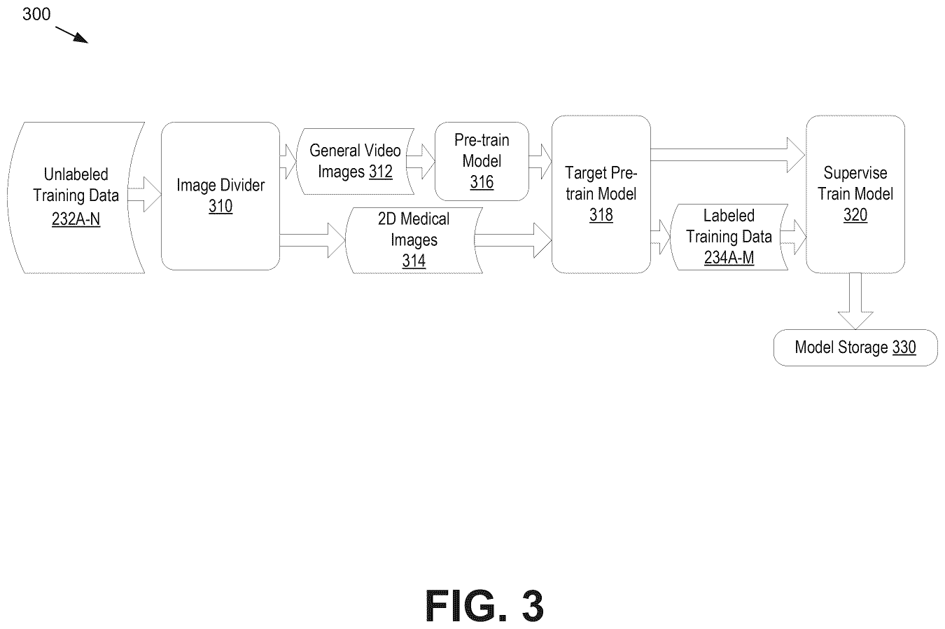

FIG. 3 illustrates a flow diagram of an example model training data flow 300 for training an AI model such as a video transformer model for medical 3D segmentation, in accordance with some embodiments of the present disclosure. In embodiments, the model training data flow 300 may be performed by the dental identification system 212 and/or the model training system 220. The model training data flow 300 may be performed by processing logic executed by a processor of a computing device. The model training data flow 300 may include operations for training the model 223.

The model training data flow 300 may include unlabeled training data 232A-N being provided to an image divider 310. The image divider 310 may accept image or video data as input and may divide the input into multiple images (referred to, herein as “patches”). Where the input is a video, the image divider 310 may first divide the video into a sequence of individual video frames, and then the image divider 310 may divide each video frame into multiple patches. Where the input is 3D image data (e.g., a 3D image, 3D volume, 3D surfaces, etc.), the image divider 310 may first divide the 3D image data depth-wise into a sequence of 2D images, and then the image divider 310 may divide each 2D image into multiple patches. The unlabeled training data 232A-N may include a general video dataset and 3D medical image data. In embodiments, the general video dataset is larger than a dataset of 3D medical image data. For example, as seen in FIG. 3, a first unlabeled training dataset 232A may include a general video dataset, and the image divider 310 may divide the general video dataset into one or more general video images 312. As also seen in FIG. 3, one or more second unlabeled training datasets 232A-N may include one or more 3D medical images, and the image divider 310 may divide the one or more 3D medical images into multiple 2D medical images 314.

The general video images 312 may be used to pre-train 316 a model 223. Pre-training the model 223 may include embedding the patches of the general video images 312 into a format the model 223 can process. Positional encodings may be added to retain information about the location of each patch within its associated video frame. The model 223 may use a combination of spatial and temporal transformers to learn the relationships between these patches, both within and across video frames. A process of forward and backward passes may be used, and the model 223 may adjust its internal parameters. The iterative pre-training process 316 may allow the model 223 to learn complex patterns and representations within the general video images 312. The pre-trained model 223 may undergo target pre-training 318. Target pre-training 318 may be similar to pre-training 316 the model 223. However, instead of being trained on general video images 312, the target pre-training 318 may train the model 223 on the patches of the 2D medical images 314.

The model 223 may undergo supervised training 320. The supervised training 320 may include training the model 223 on labeled training data 234A-M. The labeled training data 234A-M may be a smaller data set than the dataset of unlabeled 3D medical image data in embodiments. In one embodiment, the supervised training 320 may include providing the model 223 an item of training data from the labeled training data 234A-M. The model 223 may process the input image of the training data item and generate a predicted segmentation mask. A loss function, such as cross-entropy loss, can quantify the difference between the predicted mask and the ground truth mask, comparing pixel-wise anatomical structure classes. The training process may use the loss values to adjust the model's 223 internal parameters (e.g., weights and biases) through backpropagation. This iterative process of forward propagation (generating predictions), loss calculation, and backpropagation (parameter update) may continue until the model's 223 performance on a validation set plateaus or reaches a desired level. The trained model 223 may then be stored in a model storage 330 of the model training system 220 or the datastore 230.

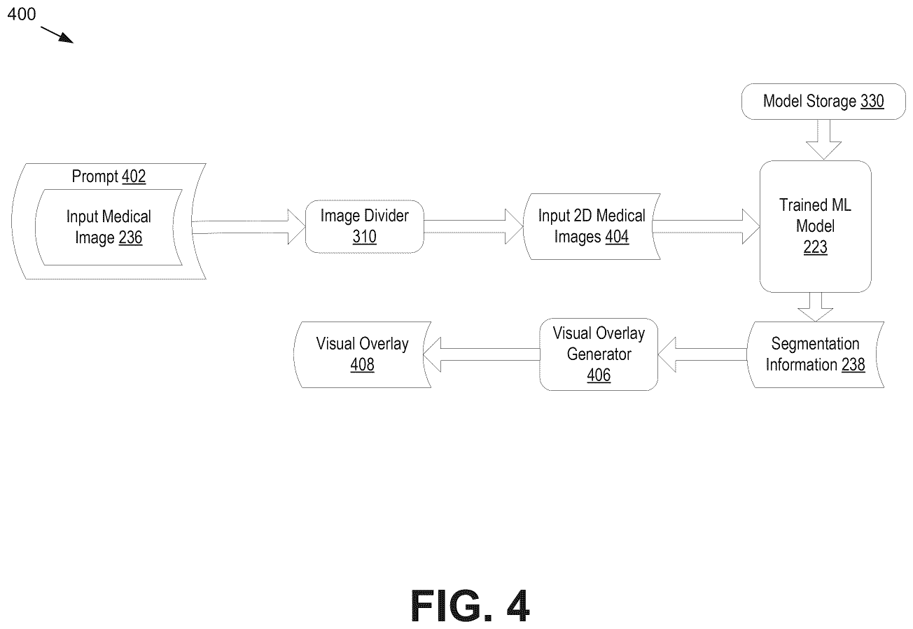

FIG. 4 illustrates a flow diagram of an example data flow 400 for using a trained AI model such as a video transformer model for medical 3D segmentation, in accordance with some embodiments of the present disclosure. The trained AI model may be trained to process a temporal sequence of 2D medical images that were generated from a 3D medical image to generate segmentation information thereof. The data flow 400 may include one or more operations for using the model 223 to generate the segmentation information 238. The data flow 400 may include receiving a prompt 402. The prompt 402 may include the input medical image 236. The prompt 402 may include data compatible with the model 223 that indicates that the model 223 is to perform an image segmentation task on the input medical image 236.

The input medical image 236 may be provided to the image divider 310. The input medical image 236 may include 3D image data, and the image divider 310 may first divide the 3D image data depth-wise into a sequence of 2D images, and then the image divider 310 may divide each 2D image into multiple patches to form one or more input 2D medical images 404. The sequence of 2D images and/or the patches of the sequence of 2D images may be arranged in a temporal sequence in embodiments. The input 2D medical images 404 may be provided to the trained model 223 in sequence as input. The trained model 223 may be retrieved from the model storage 330. The model 223 may process the input 2D medical images 404 to generate segmentation information 238 for the input medical image 236.

The segmentation information 238 may be provided to a visual overlay generator 406. The visual overlay generator 406 may generate a visual overlay 408 based on the segmentation information 238. The visual overlay 408 may include data that indicates how to modify the input medical image 236 to visually indicate different classes of anatomical structure contained in the input medical image 236. In embodiments, 3D medical segmentation information may be provided as an overlay on the 3D medical image data 236. In some embodiments, a visualization system may receive the input medical image 236 and the visual overlay 408 as input, and the visualization system may display the input medical image 236 on a UI. The UI may display the input medical image 236 modified by the visual overlay 408 to indicate different classes of anatomical structure, for example, using different colors.

In some embodiments, the visual overlay generator 406 may receive additional medical image data, which may have a different image modality than the input medical image 236. For example, medical image 236 may be CBCT scan data, and the additional medical image data may be intraoral scan data, a 2D intraoral image, a 2D face image, an x-ray image (e.g., a bite-wing x-ray image, a periodontal x-ray image, a panoramic x-ray image, etc.), a 3D model generated from intraoral scan data, and so on. The visual overlay generator 406 may use the segmentation information 238 to generate an overlay for the additional medical image data.

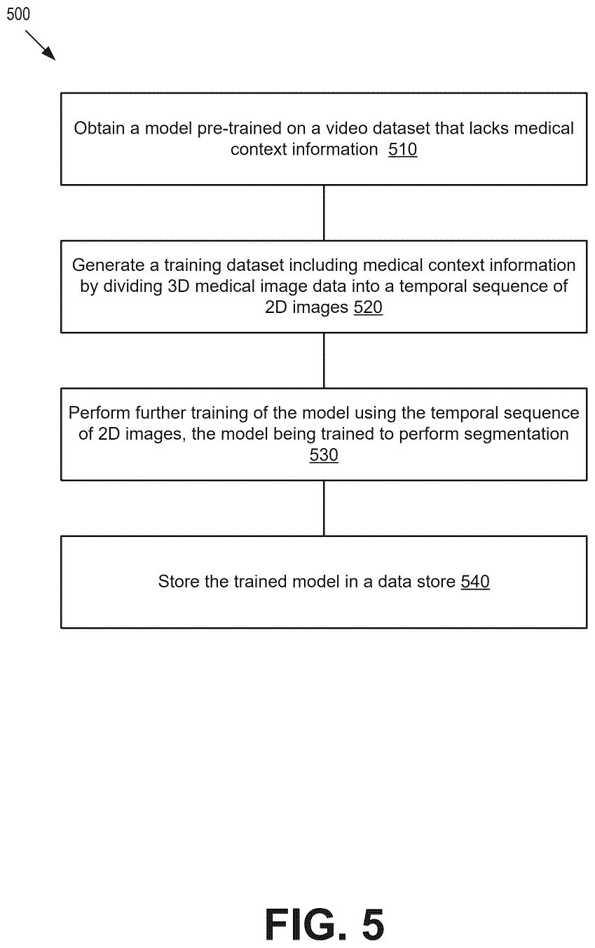

FIG. 5 illustrates a flow diagram of a method 500 for training an AI model such as a video transformer model for medical 3D segmentation, in accordance with embodiments of the present disclosure. The method 500 may be performed by processing logic that comprises hardware (e.g., circuitry, dedicated logic, programmable logic, microcode, etc.), software (such as instructions run on a processing device), or a combination thereof. The method 500 may be performed by one or more components of the system 200 of FIG. 2 or the model training data flow 300 of FIG. 3.

At block 510, processing logic obtains a model pre-trained on a general video dataset. The model pre-trained on the general video dataset may include a video transformer model. The model pre-trained on the general video dataset may include the model 223 after undergoing the pre-training 316 of the model training data flow 300 of FIG. 3. The general video dataset may include the general video images 312 derived from unlabeled training data 232A. The general video dataset may include one or more videos that lack medical context information. In one embodiment, the model training subsystem 224 of FIG. 2 may perform one or more operations of block 510.

At block 520, processing logic generates a training dataset that includes medical context information. Generating the training dataset that includes medical context information may include dividing each 3D medical image data item of one or more 3D medical image data items into a set of 2D images. Generating the training dataset may further include, for each set of 2D images, generating a temporal sequence of the set of 2D images. The one or more 3D medical image data items may include 3D medical images of one or more sets of unlabeled training data 232B-N. The sets of 2D images may include the 2D medical images 314 of the model training data flow 300. The image divider 310 may divide the 3D medical image data items into the sets of 2D images and may temporally sequence the sets of 2D images. For example, as discussed above, a 3D medical image may first be divided depth-wise into a sequence of multiple 2D images, and each 2D image may then be divided into sets of patches. In one embodiment, the model training subsystem 224 may perform one or more operations of block 520.

In some embodiments, the one or more 3D medical image data items may include CBCT images, CT images, MRI images, or other types of medical images. In one embodiment, the training dataset may include a labeled training dataset. Each 3D medical image data item of the labeled training dataset may include labels of anatomical structures. The anatomical structures may include a tooth, a tooth type, a nerve, a bone, a sinus, gingiva, or other anatomical structures.

At block 530, processing logic performs further training of the model 223 using the temporal sequence of the set of 2D medical images 314 from one or more of the 3D medical image data items. The model 223 may be trained to perform segmentation of temporal sequences of 2D images generated from the 2D medical images 314. In some embodiments, the model training subsystem 224 may perform one or more operations of block 530.

In one embodiment, the further training of the model 223 may include retraining the model 223 using a first set of unlabeled 3D medical image data items. Retraining the model 223 on the first set of unlabeled 3D medical image data items may include the target pre-training 318 of the model training data flow 300. The first set of unlabeled 3D medical image data may include the 2D medical images 314, which the image divider 310 may have generated from unlabeled training data 232B-N that included unlabeled 3D medical images.

In some embodiments, the further training of the model 223 may include fine-tuning the model 223 using a second set of labeled 3D medical image data items. The fine-tuning may include the supervised training 320 of the model training data flow 300. For example, as discussed above, the supervised training 320 may include providing the model 223 an item of training data from the labeled training data 234A-M. The model 223 may process the input image of the training data item to generate a predicted segmentation mask, and the model 223 may update one or more of its parameters based on a comparison of the predicted segmentation mask to a ground truth segmentation mask. The further training may include validating the model 223 using a corresponding set of features of a validation set.

As discussed above, the model 223 may include a video transformer model, and the transformer model may include an encoder-decoder architecture. The decoder of the video transformer model may include an image reconstruction decoder. The image reconstruction decoder may include a decoder trained and/or configured to reconstruct the video data from a vector space output by the model's 223 encoder, as discussed above. The model 223 may further include an image reconstruction head, which may generate individual video frames or sequences of video frames of the reconstructed video data. The image reconstruction head may obtain the output of the image reconstruction decoder, use one or more convolutional or deconvolutional layers (sometimes combined with residual connections or other architectural elements) to upsample the feature maps and produce the video frame(s).

In some embodiments, prior to the fine-tuning, the model 223 may include the image reconstruction decoder and the image reconstruction head. Performing the fine-tuning on the model 223 may include replacing the image reconstruction head with an image segmentation head. The image segmentation head may obtain the output of the image segmentation decoder, use one or more convolutional or deconvolutional layers to upsample the feature maps and produce segmentation information 238 indicating classes of objects contained in an image input into the model 223.

At block 540, processing logic stores the trained model 223 in a datastore. The datastore may include the datastore 230 of FIG. 2. The datastore may include a datastore of the model training system 220 or the dental treatment system 210. The trained model 223 may be ready for use by the dental identification system 212 to segment one or more medical images.

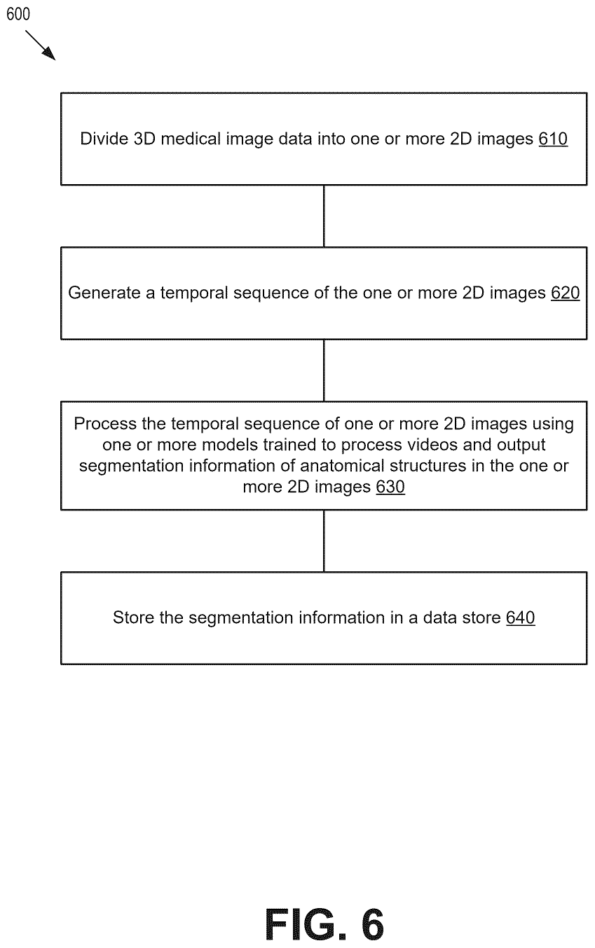

FIG. 6 illustrates a flow diagram of a method 600 for using a video transformer model for medical 3D segmentation, in accordance with embodiments of the present disclosure. The method 600 may be performed by processing logic that comprises hardware, software, or a combination thereof. The method 600 may be performed by one or more components of the system 200 of FIG. 2 or the data flow 400 of FIG. 4. For example, in some embodiments, the dental identification system 212 may perform one or more of the operations of the method 600.

At block 610, processing logic divides 3D medical image data into a plurality of 2D images. In one embodiment, processing logic divides the 3D medical image data into 16 or more 2D images. The 3D medical image data may include the input medical image 236 of FIGS. 2 and 4, and the plurality of 2D images may include the input 2D medical images 404 of FIG. 4. In one embodiment, the image divider 310 may divide the input medical image 236 into the plurality of input 2D medical images 404, as discussed above in relation to FIG. 4.

In some embodiments, the 3D medical image data may include CBCT scan data, MRI scan data, CT scan data, or other medical imaging data. In one embodiment, processing logic may receive the 3D medical image data from a remote computing device. For example, the 3D medical image data may be received from the client device 240A of FIG. 2, which may have generated the 3D medica image data from one or more medical imaging scans performed by the medical imaging device 242.

At block 620, processing logic generates a temporal sequence of the plurality of 2D images. In one embodiment, for each 2D image of the plurality of 2D images, processing logic may divide the 2D image into multiple image patches, and each image patch may be processed separately by one or more models 223. For example, as discussed above, the input 2D medical images may include a sequence of patches. In the sequence of patches, the patches belonging to the front layer of the of the 3D image may appear first, the patches belonging to the layer behind the front layer may appear next, and so on. For each set of patches belonging to a certain layer, the patches may be ordered spatially. For example, the patches may be ordered from top-left to bottom-right, top-left or in some other spatial ordering.

At block 630, processing logic processes the temporal sequence of the one or more input 2D medical images 404 using one or more models trained to process videos. The one or more models may include one or more of the models 223 that have undergone a training process to generate segmentation data based on an input 3D medical image. The one or more models 223 may include a video transformer model. The training process may include the training process of the model training data flow 300 of FIG. 4 or the method 500 of FIG. 5. The one or more models 223 may output segmentation information of anatomical structures in the one or more input 2D medical images 404. For example, as discussed above in relation to the model application data flow 440, the model 223 may process the input 2D medical images 404 to generate segmentation information 238 for the input medical image 236. In some embodiments, the anatomical structures depicted in the one or more input 2D medical images 404 may include a tooth, a tooth type, a bone, a sinus, a nerve, gingiva, or other anatomical structures.

At block 640, processing logic stores the segmentation information 238 in a datastore. The datastore may include the datastore 230 of FIG. 2. The datastore 230 may include some other datastore in data communication with the dental treatment system 210.

In some embodiments, processing logic may generate a visual overlay for the 3D medical image data based on the segmentation information 238 of the anatomical structures. For example, as discussed above in relation to the data flow 400 of FIG. 4, the visual overlay generator 406 may use the segmentation as input to generate the visual overlay 408. The visual overlay 408 may include data that indicates how to modify the input medical image 236 to visually indicate different classes of anatomical structure contained in the input medical image 236.

In one embodiment, processing logic may output the 3D medical image data and the visual overlay 408 to a display. In one embodiment, the display may include a display of a remote computing device. The remote computing device may include the client device 240A or the dental professional device 240B of FIG. 2. The display may include a UI of the dental treatment system 210 or the dental identification system 212 that can display the input medical image 236 modified by the visual overlay 408. A patient or dental professional can view the display and the segmented input medical image 236 to view different classes of anatomical structure contained in the input medical image 236.

In one embodiment, processing logic may send the segmentation information 238 to a remote computing device (e.g., the client device 240A or the dental professional device 240B). The remote computing device may display the segmentation information 238 with the 3D medical image data. For example, the remote computing device may include the visual overlay generator 406 that uses the segmentation information 238 as input and generates the visual overlay 408. The remote computing device may then display the input medical image 236 modified by the visual overlay 408 on a display of the remote computing device.

In some embodiments, the one or more models 223 may use a few-shot prompt to expand the classes of oral anatomical structures identified by the one or more models 223. The anatomical structures classes may include classes that the models 223 were not trained to identify during a training process (e.g., the training process of the model training data flow 300). This may expand the number of anatomical structures the models 223 can identify without additional training of the one or more models 223. In one embodiment, processing the temporal sequence 2D images using the one or more models 223 may include providing a model prompt to a video transformer model of the one or more models 223. The prompt may include the prompt 402 of the model application workflow 440. The prompt 422 may include the input medical image 236 (e.g., the 3D medical image data of block 610). The prompt 422 may include example 3D medical image data. The example 3D medical image data may include a 3D medical image augmented with segmentation data indicating one or more classes of anatomical structure in the example 3D medical image data. The segmentation data may include a first label indicating a class of anatomical structure. The labeled training data 234A-M may not have included any labels that match the first label, and thus, the one or more models 223 may not have been trained to identify the anatomical structure class indicated by the first label. The prompt 402 may further include an instruction for a video transformer model to output segmentation information 238 that includes the first label.

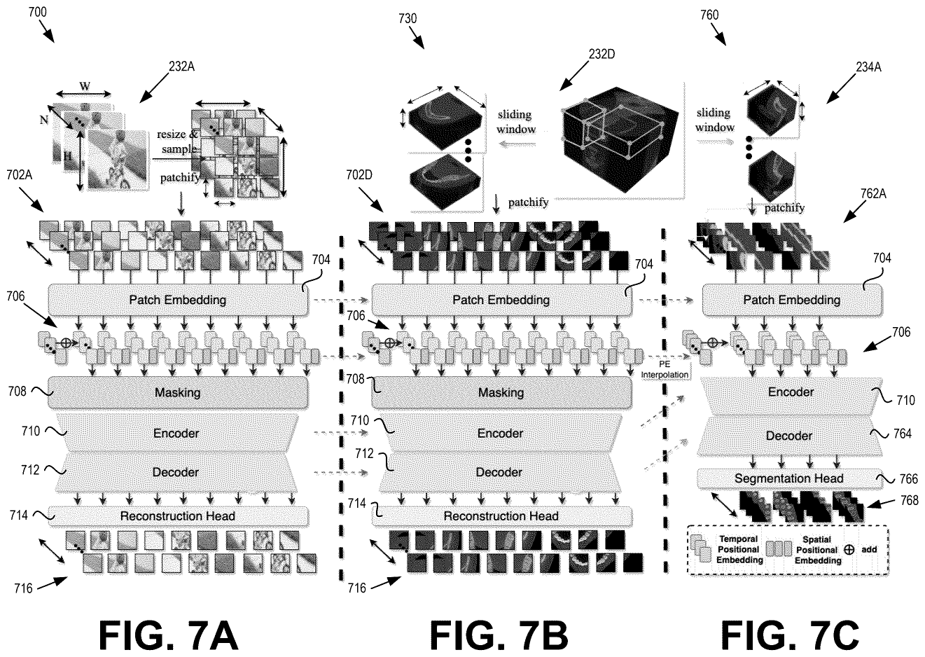

FIGS. 7A-C illustrate flow diagrams of example data flows for training video transformer models for medical 3D segmentation during a training process, in accordance with some embodiments of the present disclosure. As can be seen from the example data flow 700 of FIG. 7A, a video transformer model (which may be a model 223 of FIG. 2) may receive unlabeled training data 232A. The unlabeled training data 232A may include a general video dataset. The general video dataset may include N video frames, and each video frame may be of height H and width W. The general video dataset may be resized, sampled, and/or patchified to generate one or more patches 702A based on the general video dataset.

The patches 702 may be provided to a patch embedding model 704 of a video transformer model. The patch embedding model 704 may include a model configured to generate patch embeddings 706 based on the patches 702. A patch embedding 706 may include a vector representation of the patch in a vector space. The patch embeddings 706 may be modified to include temporal positioning data and/or spatial positioning data to indicate to a temporal and/or spatial position of the associated patch embedding 706 the video transformer model.

The patch embeddings 706 may be provided to a masking model 708 of the video transformer model. The masking model 708 may randomly select one or more patch embeddings 706 to replace with a mask token. An encoder 710 of the video transformer model may predict the masked tokens based on the context provided by other unmasked patch embeddings 706. As discussed above, the encoder 710 may include a model that can encode the patch embeddings 706 into a vector space representation. As also discussed above, the decoder 712 of the video transformer model may reconstruct the patch embeddings 706 from the output of the encoder 710 to generate an output used to reconstruct the input video data. The video transformer model may include an image reconstruction head 714. As discussed above, the image reconstruction head 714 may generate sequences of video frames 716 based on the output of the decoder 712. The image reconstruction head 714 may use one or more convolutional or deconvolutional layers to upsample the feature maps and produce the video frames 716. The training engine 225 may calculate a loss between the video frames 716 and the unlabeled training data 232A and use the loss to modify internal parameters (e.g., weights and biases) of one or more components of the video transformer model. The data flow 700 may include using the image divider 310 to divide the unlabeled training data 232A into the general video images 312 and may include pre-training 316 the video transformer model, as discussed above in relation to FIG. 3.

FIG. 7B depicts an example data flow 730 for training the video transformer model of FIG. 7A after the video transformer model has undergone the pre-training on the general video dataset of the unlabeled training data 232A during the data flow 700. The video transformer model may receive unlabeled training data 232D. The unlabeled training data 232D may include one or more unlabeled 3D medical images. The model training subsystem 224 may divide the one or more unlabeled 3D medical images to patches 702D, as discussed above. The video transformer model may process the patches 702D similar to the processing of the patches 702A described above in relation to the data flow 700 of FIG. 7A. The data flow 730 may include using the image divider 310 to divide the unlabeled training data 232D into the 2D medical images 314 and target pre-training 318 the video transformer model, as discussed above in relation to FIG. 3.

FIG. 7C depicts an example data flow 760 for training the video transformer model of FIGS. 7A and 7B after the video transformer model has undergone the pre-training on the general video dataset of the unlabeled training data 232A during the data flow 700 and has undergone the target pre-training on one or more 3D medical images during the data flow 730. The video transformer model may receive labeled training data 234A. The labeled training data 234A may include one or more 3D medical images. The model training subsystem 224 may divide the one or more 3D medical images into patches 762A, which may be similar to dividing the one or more unlabeled 3D medical images into patches 702D, as described above in relation to FIG. 7B. In some embodiments, a 3D medical image of the labeled training data 234D may be of a different size than the 3D medical images of the unlabeled training data 232D, and thus, may produce more or fewer patches 762A.

The patches 762A may be provided to the patch embedding model 704, which may generate patch embeddings 706 based on the patches 762A. The patch embeddings 706 may be modified to include temporal positioning data and/or spatial positioning data to indicate a temporal and/or spatial position of the respective patch embeddings 706. The patch embeddings 706 may be provided to the encoder 710 of the video transformer model, which may encode the patch embeddings 706 into a vector space representation. The encoded patch embeddings may be provided to an image segmentation decoder 764, which may have replaced the previous image reconstruction head. As discussed above, the image segmentation decoder 764 may include a decoder that can be trained or configured to generate segmentation data based on output from the encoder 710. The output of the image segmentation decoder 764 may be provided to an image segmentation head 766. As also discussed above, the image segmentation head 766 may obtain the output of the image segmentation decoder 764, use one or more convolutional or deconvolutional layers to upsample the feature maps and produce segmentation information 768 indicating classes of objects contained in the input 3D medical image of the labeled training data 234A. The segmentation information 768 can be compared to the segmentation information of the label that corresponds to the input 3D medical image, and the training engine 225 may calculate a loss between the segmentation information 768 and the label of the input 3D medical image and use the loss to modify internal parameters of one or more components of the video transformer model. The data flow 760 may include using the labeled training data 234A-M as part of the supervised training 320, as discussed above in relation to FIG. 3.

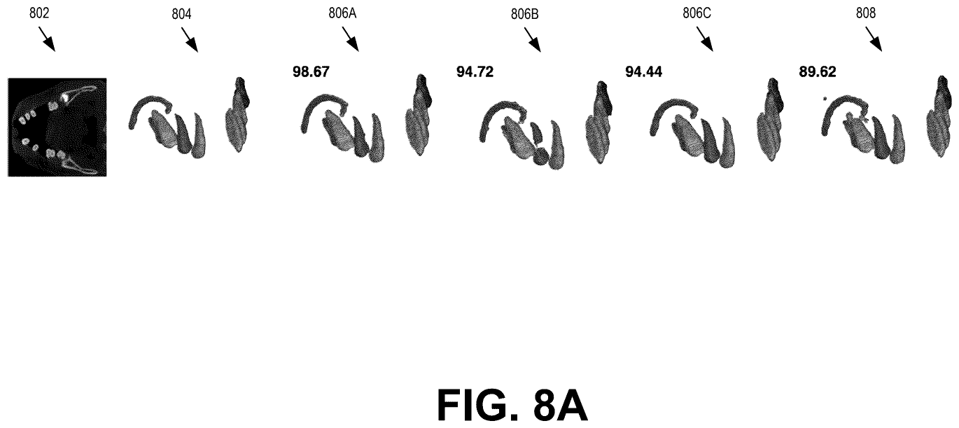

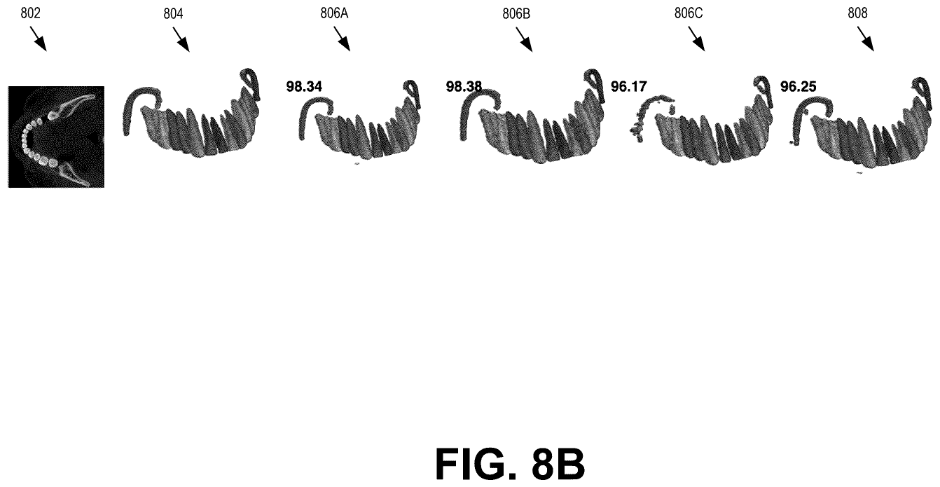

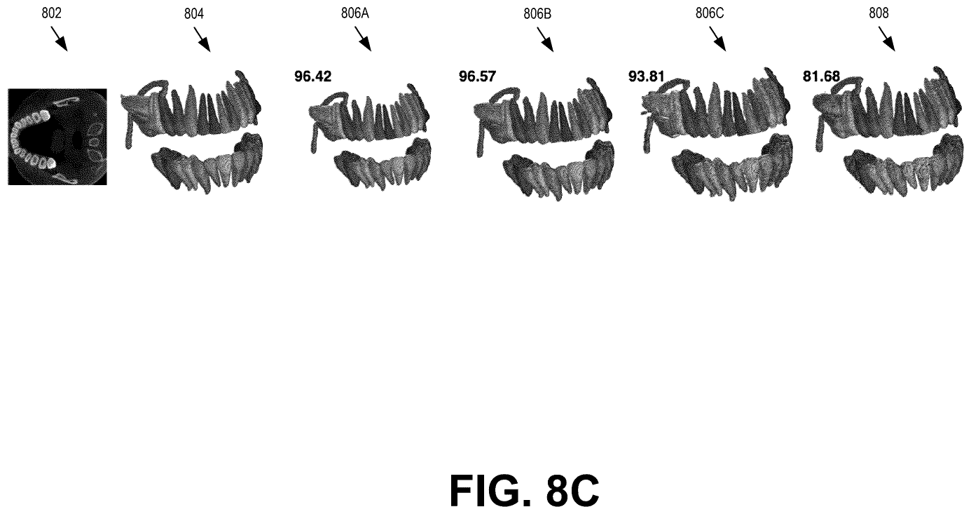

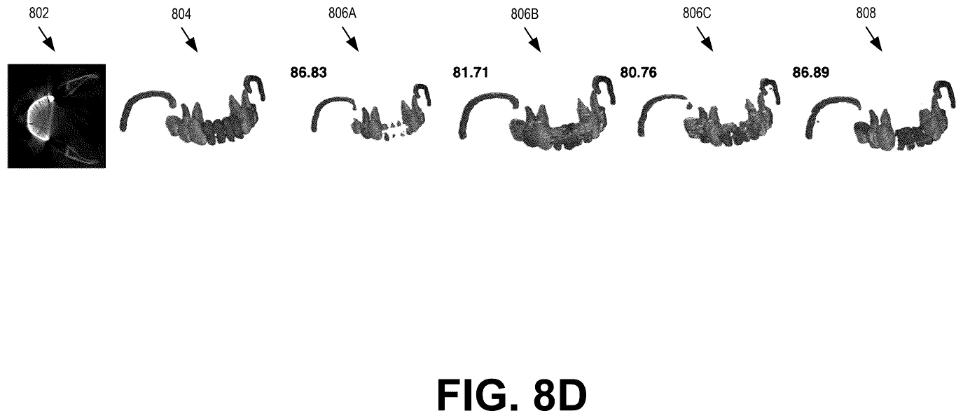

FIG. 8A-D illustrate example 2D medical image data and corresponding visual overlays of segmentation information, in accordance with some embodiments of the present disclosure. In each of FIGS. 8A-D, a 2D medical image 802 may include a 2D image from the one or more input 2D medical images 404. The 2D medical image 802 may be associated with a visual overlay 804 that indicates ground truth segmentation information for the 2D medical image 802. The 2D medical image 802, along with other 2D medical images generated from the same 3D medical image, may be provided to a model 223 as input, and the model 223 may generate segmentation information 238. The visual overlay generator 406 of FIG. 4 may use the segmentation information 238 to generate a visual overlay 806A-C. Each visual overlay 806A, B, and C may be a visual overlay 408 generated by the model 223. The visual overlays 806A-C may be different because a video transformer of the model 223 may have different parameters or other configurations, which may cause their respective outputs to differ. In one embodiment, the visual overlay 808 may include a visual overlay 408 generated by an AI model that is not based on a video transformer of the embodiments of the present disclosure. For example, the AI model may be a CNN-based image segmentation model. The visual overlays 806A-C generated from segmentation information 238 produced by a video transformer model disclosed herein may be more accurate than the visual overlay 808 produced by another type of AI model.

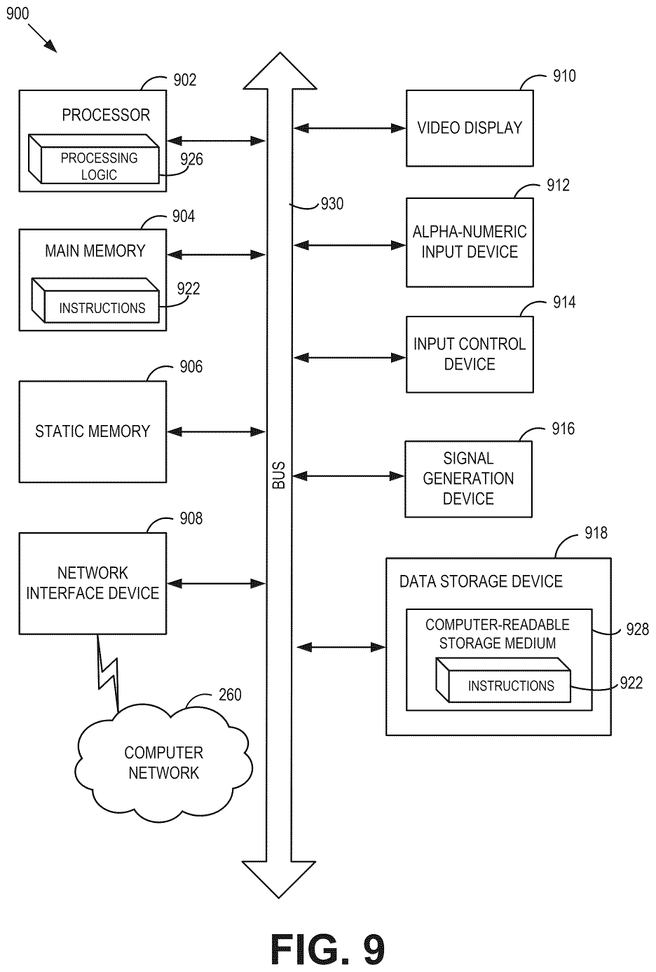

FIG. 9 illustrates a block diagram of an example processing device 900 operating in accordance with one or more aspects of the present disclosure. In one implementation, the processing device 900 can be a part of any computing device of FIG. 1, or any combination thereof. Example processing device 900 can be connected to other processing devices in a LAN, an intranet, an extranet, and/or the Internet. The processing device 900 can be a personal computer (PC), a set-top box (STB), a server, a network router, switch or bridge, or any device capable of executing a set of instructions (sequential or otherwise) that specify actions to be taken by that device. Further, while only a single example processing device is illustrated, the term “processing device” shall also be taken to include any collection of processing devices (e.g., computers) that individually or jointly execute a set (or multiple sets) of instructions to perform any one or more of the methods discussed herein.

The example processing device 900 can include a processor 902 (e.g., a CPU), a main memory 904 (e.g., read-only memory (ROM), flash memory, dynamic random access memory (DRAM) such as synchronous DRAM (SDRAM), etc.), a static memory 906 (e.g., flash memory, static random access memory (SRAM), etc.), and a secondary memory (e.g., a data storage device 918), which can communicate with each other via a bus 930.

The processor 902 may represent one or more general-purpose processing devices such as a microprocessor, central processing unit, or the like. More particularly, the processor 902 can be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 902 can also be one or more special-purpose processing devices such as an application specific integrated circuit (ASIC), a field programmable gate array (FPGA), a digital signal processor (DSP), network processor, or the like. In accordance with one or more aspects of the present disclosure, the processor 902 can be configured to execute instructions (e.g. the processing logic 926 can implement the dental identification system 212, the treatment planning system 214, the model training system 220, or other components discussed herein).

The example processing device 900 can further include a network interface device 908, which can be communicatively coupled to the computer network 260. The example processing device 900 can further include a video display 910 (e.g., a liquid crystal display (LCD), a touch screen, or a cathode ray tube (CRT)), an alphanumeric input device 912 (e.g., a keyboard), an input control device 914 (e.g., a cursor control device, a touch-screen control device, a mouse), and a signal generation device 916 (e.g., an acoustic speaker).

The data storage device 918 can include a computer-readable storage medium (or, more specifically, a non-transitory computer-readable storage medium) 928 on which is stored one or more sets of executable instructions 922. In accordance with one or more aspects of the present disclosure, executable instructions 922 can comprise executable instructions (e.g. instructions for implementing the dental identification system 212, the treatment planning system 214, the model training system 220, or other components discussed herein or for implementing one or more of the methods 500 or 600).

The executable instructions 922 can also reside, completely or at least partially, within the main memory 904 and/or within the processor 902 during execution thereof by the example processing device 900, the main memory 904, and the processor 902 also constituting computer-readable storage media. The executable instructions 922 can further be transmitted or received over a network (e.g., the computer network 260) via network interface device 908.

While the computer-readable storage medium 928 is shown in FIG. 9 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some examples have been described with reference to dental treatment plans that include a series of stages that are each associated with a different orthodontic aligner. It should be understood that any such examples described with reference to dental treatment and a series of orthodontic aligners also applies to palatal expansion treatment and a series of palatal expanders. For palatal expansion treatment, a similar process may be performed as described above for orthodontic treatment. For example, an upper and/or lower dental arch and upper palate may be scanned using an intraoral scanner 146 to generate a 3D dentition model 132 of the dental arch(es) and of the upper palate. A final shape (e.g., width) of the upper palate may be determined, and a series of treatment stages to progress from a current upper palate shape and a final target upper palate shape may be determined. For each treatment stage, a polymeric palatal expander may be fabricated by the manufacturing equipment 250, either via direct fabrication (e.g., direct 3D printing) or by 3D printing of a mold and thermoforming a palatal expander over the mold. Materials used for palatal expanders may be the same as or different from those used for orthodontic aligners in embodiments.

Any of the methods (including user interfaces) described herein can be implemented as software, hardware or firmware, and can be described as a non-transitory machine-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, computer models (e.g., for additive manufacturing) and instructions related to forming a dental device can be stored on a non-transitory machine-readable storage medium.

It should be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The embodiments of methods, hardware, software, firmware, or code set forth above can be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

In the foregoing specification, a detailed description has been given with reference to specific exemplary embodiments. It will, however, be evident that various modifications and changes can be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment, embodiment, and/or other exemplarily language does not necessarily refer to the same embodiment or the same example, but can refer to different and distinct embodiments, as well as potentially the same embodiment.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and can not necessarily have an ordinal meaning according to their numerical designation.

A digital computer program, which can also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. The essential elements of a digital computer a central processing unit for performing or executing instructions and one or more memory devices for storing instructions and digital data. The central processing unit and the memory can be supplemented by, or incorporated in, special purpose logic circuitry or quantum simulators. Generally, a digital computer will also include-or be operatively coupled to receive digital data from or transfer digital data to, or both-one or more mass storage devices for storing digital data, e.g., magnetic, magneto-optical disks, optical disks, or systems suitable for storing information. However, a digital computer need not have such devices.

Digital computer-readable media suitable for storing digital computer program instructions and digital data include all forms of non-volatile digital memory, media, and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks.

Control of the various systems described in this specification, or portions of them, can be implemented in a digital computer program product that includes instructions that are stored on one or more non-transitory machine-readable storage media, and that are executable on one or more digital processing devices. The systems described in this specification, or portions of them, can each be implemented as an apparatus, method, or system that can include one or more digital processing devices and memory to store executable instructions to perform the operations described in this specification.

While this specification contains many specific embodiment details, these should not be construed as limitations on the scope of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Some example implementations of the present disclosure are set forth below.

A first example implementation is a method comprising: dividing three-dimensional (3D) medical image data into a plurality of two-dimensional (2D) images; generating a temporal sequence of the plurality of 2D images; processing the temporal sequence of the plurality of 2D images using one or more models trained to process videos, wherein the one or more models output segmentation information of anatomical structures in the plurality of 2D images; and storing the segmentation information in a datastore.

A second example implementation may extend the first example implementation. In the second example implementation, the anatomical structures comprise at least one of teeth, bones, sinuses, nerves, or gingiva.

A third example implementation may extend any of the first through second example implementations. In the third example implementation, the 3D medical image data comprises at least one of cone beam computed tomography (CBCT) scan data, magnetic resonance imaging (MRI) scan data, or computed tomography (CT) scan data.

A fourth example implementation may extend any of the first through third example implementations. The fourth example implementation further comprises: generating a visual overlay for the 3D medical image data based on the segmentation information of the anatomical structures; and outputting the 3D medical image data and the visual overlay to a display.

A fifth example implementation may extend any of the first through fourth example implementations. The fifth example implementation further comprises: receiving the 3D medical image data from a remote computing device; sending the segmentation information to the remote computing device; and displaying the segmentation information with the 3D medical image data by the remote computing device.

A sixth example implementation may extend any of the first through fifth example implementations. In the sixth example implementation, the medical image data has a first imaging modality. The sixth example implementation further comprises: receiving additional medical image data having a second imaging modality; generating a visual overlay for the additional medical image data based on the segmentation information of the anatomical structures; and outputting the additional medical image data and the visual overlay to a display.

A seventh example implementation may extend any of the first through sixth example implementations. The seventh example implementation further comprises: for each 2D image of the plurality of 2D images, dividing the 2D image into a plurality of image patches, wherein each image patch of the plurality of image patches is processed separately by the one or more models.

An eighth example implementation may extend any of the first through seventh example implementations. In the eighth example implementation, the one or more models comprise a video transformer model.

A ninth example implementation may extend any of the first through eighth example implementations. In the ninth example implementation, the processing the temporal sequence of the plurality of 2D images using the one or more models comprises providing, to the video transformer model, a model prompt comprising: example 3D medical image data, wherein a segment of the example 3D medical image data is labeled with a first label; and an instruction for the video transformer model to output segmentation information in the plurality of 2D images that corresponds to the first label.

A tenth example implementation is a method comprising: obtaining a model pre-trained on a general video dataset; generating a training dataset comprising medical context information, by: dividing each three-dimensional (3D) medical image data item of a plurality of 3D medical image data items into a set of two-dimensional (2D) images, and for each set of 2D images, generating a temporal sequence of the set of 2D images; performing further training of the model using the temporal sequence of the set of 2D images from one or more of the 3D medical image data items, wherein the model is trained to perform segmentation of temporal sequences of 2D images generated from 3D medical images; and storing the trained model in a datastore.

An eleventh example implementation may extend the tenth example implementation. In the eleventh example implementation, the plurality of 3D medical image data items comprises at least one of: cone beam computed tomography (CBCT) images; computed tomography (CT) images; or magnetic resonance imaging (MRI) images.

A twelfth example implementation may extend any of the tenth through eleventh example implementations. In the twelfth example implementation, the general video dataset comprises a plurality of videos that lack medical context information.

A thirteenth example implementation may extend any of the tenth through twelfth example implementations. In the thirteenth example implementation, the training dataset comprises a labeled training dataset and an unlabeled training dataset, and wherein each 3D medical image data item of the labeled training dataset comprises labels of anatomical structures.

A fourteenth example implementation may extend any of the tenth through thirteenth example implementations. In the fourteenth example implementation, the anatomical structures comprise at least one of: a tooth type; or a nerve.

A fifteenth example implementation may extend any of the tenth through fourteenth example implementations. In the fifteenth example implementation, performing the further training comprises: retraining the model using a first set of unlabeled 3D medical image data items; and fine-tuning the model using a second set of labeled 3D medical image data items.

A sixteenth example implementation may extend any of the tenth through fifteenth example implementations. In the sixteenth example implementation, the model comprises a video transformer model.

A seventeenth example implementation may extend any of the tenth through sixteenth example implementations. In the seventeenth example implementation: prior to performing the fine-tuning, the video transformer model comprises an image reconstruction decoder and an image reconstruction head; and performing the fine-tuning on the video transformer model comprises: replacing the image reconstruction head with an image segmentation head.

An eighteenth example implementation is a system comprising: one or more processors; and a memory coupled to the one or more processors, the memory storing computer program instructions that, when executed by the one or more processors, perform a computer-implemented method comprising: dividing three-dimensional (3D) medical image data into a plurality of two-dimensional (2D) images; generating a temporal sequence of the plurality of 2D images; processing the temporal sequence of the plurality of 2D images using one or more models trained to process videos, wherein the one or more models output segmentation information of anatomical structures in the plurality of 2D images; and storing the segmentation information in a datastore.

A nineteenth example implementation may extend the eighteenth example implementation. In the nineteenth example implementation, the anatomical structures comprise at least one of teeth, bones, sinuses, nerves, or gingiva.

A twentieth example implementation may extend any of the eighteenth through nineteenth example implementations. In the twentieth example implementation, the 3D medical image data comprises at least one of cone beam computed tomography (CBCT) scan data, magnetic resonance imaging (MRI) scan data, or computed tomography (CT) scan data.

A twenty-first example implementation may extend any of the eighteenth through twentieth example implementations. In the twenty-first example implementation, the computer-implemented method further comprises: generating a visual overlay for the 3D medical image data based on the segmentation information of the anatomical structures; and outputting the 3D medical image data and the visual overlay to a display.

A twenty-second example implementation may extend any of the eighteenth through twenty-first example implementations. In the twenty-second example implementation, the computer-implemented method further comprises: sending the segmentation information to a remote computing device; and displaying the segmentation information with the 3D medical image data by the remote computing device.

A twenty-third example implementation may extend any of the eighteenth through twenty-second example implementations. In the twenty-third example implementation, the computer-implemented method further comprises receiving the 3D medical image data from a remote computing device.

A twenty-fourth example implementation may extend any of the eighteenth through twenty-third example implementations. In the twenty-fourth example implementation, the computer-implemented method further comprises: for each 2D image of the plurality of 2D images, dividing the 2D image into a plurality of image patches, wherein each image patch of the plurality of image patches is processed separately by the one or more models.

A twenty-fifth example implementation may extend any of the eighteenth through twenty-fourth example implementations. In the twenty-fifth example implementation, the one or more models comprise a video transformer model.

A twenty-sixth example implementation may extend any of the eighteenth through twenty-fifth example implementations. In the twenty-sixth example implementation, the processing the temporal sequence of the plurality of 2D images using the one or more models comprises providing, to the video transformer model, a model prompt comprising: example 3D medical image data, wherein a segment of the example 3D medical image data is labeled with a first label; and an instruction for the video transformer model to output segmentation information in the plurality of 2D images that corresponds to the first label.

A twenty-seventh example implementation is a system comprising: one or more processors; and a memory coupled to the one or more processors, the memory storing computer program instructions that, when executed by the one or more processors, perform a computer-implemented method comprising: obtaining a model pre-trained on a video dataset that lacks medical context information; generating a training dataset comprising medical context information, by: dividing each three-dimensional (3D) medical image data item of a plurality of 3D medical image data items into a set of two-dimensional (2D) images, and for each set of 2D images, generating a temporal sequence of the set of 2D images; performing further training of the model using the temporal sequence of the set of 2D images from one or more of the 3D medical image data items, wherein the model is trained to perform segmentation of temporal sequences of 2D images generated from the 3D medical images; and storing the trained model in a datastore.

A twenty-eighth example implementation may extend the twenty-seventh example implementation. In the twenty-eighth example implementation, the plurality of 3D medical image data items comprises at least one of: cone beam computed tomography (CBCT) images; computed tomography (CT) images; or magnetic resonance imaging (MRI) images.

A twenty-ninth example implementation may extend any of the twenty-seventh through twenty-eighth example implementations. In the twenty-ninth example implementation, the computer-implemented method further comprises: for each 2D image of the set of 2D images, dividing the 2D image into a plurality of image patches, wherein the further training is performed using the plurality of image patches.

A thirtieth example implementation may extend any of the twenty-seventh through twenty-ninth example implementations. In the thirtieth example implementation, the training dataset comprises a labeled training dataset, and wherein each 3D medical image data item of the labeled training dataset comprises labels of anatomical structures.

A thirty-first example implementation may extend any of the twenty-seventh through thirtieth example implementations. In the thirty-first example implementation, the anatomical structures comprise at least one of: a tooth type; or a nerve.

A thirty-second example implementation may extend any of the twenty-seventh through thirty-first example implementations. In the thirty-second example implementation, performing the further training comprises: retraining the model using a first set of unlabeled 3D medical image data items; and fine-tuning the model using a second set of labeled 3D medical image data items.

A thirty-third example implementation may extend any of the twenty-seventh through thirty-second example implementations. In the thirty-third example implementation, the model comprises a video transformer model.

A thirty-fourth example implementation may extend any of the twenty-seventh through thirty-third example implementations. In the thirty-fourth example implementation: prior to performing the fine-tuning, the video transformer model comprises an image reconstruction decoder and an image reconstruction head; and performing the fine-tuning on the video transformer model comprises: replacing the image reconstruction decoder with an image segmentation decoder, and replacing the image reconstruction head with an image segmentation head.

A thirty-fifth example implementation is a non-transitory computer-readable storage medium with instructions stored thereon, wherein the instructions, when executed by one or more processors, perform a computer-implemented method comprising: dividing three-dimensional (3D) medical image data into a plurality of two-dimensional (2D) images; generating a temporal sequence of the plurality of 2D images; processing the temporal sequence of the plurality of 2D images using one or more models trained to process videos, wherein the one or more models output segmentation information of anatomical structures in the plurality of 2D images; and storing the segmentation information in a datastore.

A thirty-sixth example implementation may extend the thirty-fifth example implementation. In the thirty-sixth example implementation, the anatomical structures comprise at least one of teeth, bones, sinuses, nerves, or gingiva.

A thirty-seventh example implementation may extend any of the thirty-fifth through thirty-sixth example implementations. In the thirty-seventh example implementation, the 3D medical image data comprises at least one of cone beam computed tomography (CBCT) scan data, magnetic resonance imaging (MRI) scan data, or computed tomography (CT) scan data.

A thirty-eighth example implementation may extend any of the thirty-fifth through thirty-seventh example implementations. In the thirty-eighth example implementation, the computer-implemented method further comprises: generating a visual overlay for the 3D medical image data based on the segmentation information of the anatomical structures; and outputting the 3D medical image data and the visual overlay to a display.

A thirty-ninth example implementation may extend any of the thirty-fifth through thirty-eighth example implementations. In the thirty-ninth example implementation, the computer-implemented method further comprises: sending the segmentation information to a remote computing device; and displaying the segmentation information with the 3D medical image data by the remote computing device.

A fortieth example implementation may extend any of the thirty-fifth through thirty-ninth example implementations. In the fortieth example implementation, the computer-implemented method further comprises receiving the 3D medical image data from a remote computing device.

A forty-first example implementation may extend any of the thirty-fifth through fortieth example implementations. In the forty-first example implementation, the computer-implemented method further comprises: for each 2D image of the plurality of 2D images, dividing the 2D image into a plurality of image patches, wherein each image patch of the plurality of image patches is processed separately by the one or more models.

A forty-second example implementation may extend any of the thirty-fifth through forty-first example implementations. In the forty-second example implementation, the one or more models comprise a video transformer model.

A forty-third example implementation may extend any of the thirty-fifth through forty-second example implementations. In the forty-third example implementation, the processing the temporal sequence of the plurality of 2D images using the one or more models comprises providing, to the video transformer model, a model prompt comprising: example 3D medical image data, wherein a segment of the example 3D medical image data is labeled with a first label; and an instruction for the video transformer model to output segmentation information in the plurality of 2D images that corresponds to the first label.

A forty-fourth example implementation is a non-transitory computer-readable storage medium with instructions stored thereon, wherein the instructions, when executed by one or more processors, perform a computer-implemented method comprising: obtaining a model pre-trained on a video dataset that lacks medical context information; generating a training dataset comprising medical context information, by: dividing each three-dimensional (3D) medical image data item of a plurality of 3D medical image data items into a set of two-dimensional (2D) images, and for each set of 2D images, generating a temporal sequence of the set of 2D images; performing further training of the model using the temporal sequence of the set of 2D images from one or more of the 3D medical image data items, wherein the model is trained to perform segmentation of temporal sequences of 2D images generated from the 2D medical images; and storing the trained model in a datastore.

A forty-fifth example implementation may extend the forty-fourth example implementation. In the forty-fifth example implementation, the plurality of 3D medical image data items comprises at least one of: cone beam computed tomography (CBCT) images; computed tomography (CT) images; or magnetic resonance imaging (MRI) images.

A forty-sixth example implementation may extend any of the forty-fourth through forty-fifth example implementations. In the forty-sixth example implementation, the computer-implemented method further comprises: for each 2D image of the set of 2D images, dividing the 2D image into a plurality of image patches, wherein the further training is performed using the plurality of image patches.

A forty-seventh example implementation may extend any of the forty-fourth through forty-sixth example implementations. In the forty-seventh example implementation, the training dataset comprises a labeled training dataset, and wherein each 3D medical image data item of the labeled training dataset comprises labels of anatomical structures.

A forty-eighth example implementation may extend any of the forty-fourth through forty-seventh example implementations. In the forty-eighth example implementation, the anatomical structures comprise at least one of: a tooth type; or a nerve.

A forty-ninth example implementation may extend any of the forty-fourth through forty-eighth example implementations. In the forty-ninth example implementation, performing the further training comprises: retraining the model using a first set of unlabeled 3D medical image data items; and fine-tuning the model using a second set of labeled 3D medical image data items.

A fiftieth example implementation may extend any of the forty-fourth through forty-ninth example implementations. In the fiftieth example implementation, the model comprises a video transformer model.

A fifty-first example implementation may extend any of the forty-fourth through fiftieth example implementations. In the fifty-first example implementation: prior to performing the fine-tuning, the video transformer model comprises an image reconstruction decoder and an image reconstruction head; and performing the fine-tuning on the video transformer model comprises: replacing the image reconstruction decoder with an image segmentation decoder, and replacing the image reconstruction head with an image segmentation head.

A fifty-second example implementation is a system comprising: a first computing device configured to: divide three-dimensional (3D) medical image data into a plurality of two-dimensional (2D) images; generate a temporal sequence of the plurality of 2D images; and process the temporal sequence of the plurality of 2D images using one or more models trained to process videos, wherein the one or more models output segmentation information of anatomical structures in the plurality of 2D images.

A fifty-third example implementation may extend the fifty-second example implementation. In the fifty-third example implementation, the first computing device is further configured to transmit the segmentation information to a second computing device. The fifty-third example implementation further comprises: the second computing device, configured to present the segmentation information on a display.

A fifty-fourth example implementation is a system comprising: a first computing device configured to: generate a training dataset comprising medical context information, by: dividing each three-dimensional (3D) medical image data item of a plurality of 3D medical image data items into a set of two-dimensional (2D) images, and for each set of 2D images, generating a temporal sequence of the set of 2D images; and transmit the training dataset to a second computing device.

A fifty-fifth example implementation may extend the fifty-fourth example implementation. The fifty-fifth example implementation further comprises the second computing device, configured to: obtain a model pre-trained on a video dataset that lacks medical context information; obtain the training dataset from the first computing device; perform further training of the model using the temporal sequence of the set of 2D images from one or more of the 3D medical image data items, wherein the model is trained to perform segmentation of temporal sequences of 2D images generated from the 2D medical images; and store the trained model in a datastore.

A fifty-sixth example implementation is a method comprising: obtaining a model pre-trained on a general video dataset; generating a training dataset comprising medical context information, by: dividing each three-dimensional (3D) medical image data item of a plurality of 3D medical image data items into a first set of two-dimensional (2D) images, and for each first set of 2D images, generating a temporal sequence of the first set of 2D images; performing further training of the model using the temporal sequence of the first set of 2D images from one or more of the 3D medical image data items, wherein the model is trained to perform segmentation of temporal sequences of 2D images generated from the 2D medical image; dividing input 3D medical image data into a second set of 2D images; generating a temporal sequence of the second set of 2D images; processing the temporal sequence of the second set of 2D images using the models, wherein the model outputs segmentation information of anatomical structures in the second set of 2D images; and storing the segmentation information in a datastore.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method comprising:
dividing three-dimensional (3D) medical image data into a plurality of two-dimensional (2D) images;
generating a temporal sequence of the plurality of 2D images;
processing the temporal sequence of the plurality of 2D images using one or more models trained to process videos, wherein the one or more models output segmentation information of anatomical structures in the plurality of 2D images; and
storing the segmentation information in a datastore.

2. The method of claim 1, wherein the anatomical structures comprise at least one of teeth, bones, sinuses, nerves, or gingiva.

3. The method of claim 1, wherein the 3D medical image data comprises at least one of cone beam computed tomography (CBCT) scan data, magnetic resonance imaging (MRI) scan data, or computed tomography (CT) scan data.

4. The method of claim 1, further comprising:
generating a visual overlay for the 3D medical image data based on the segmentation information of the anatomical structures; and
outputting the 3D medical image data and the visual overlay to a display.

5. The method of claim 1, further comprising:
receiving the 3D medical image data from a remote computing device;
sending the segmentation information to the remote computing device; and
displaying the segmentation information with the 3D medical image data by the remote computing device.

6. The method of claim 1, wherein the 3D medical image data has a first imaging modality, the method further comprising:
receiving additional medical image data having a second imaging modality;
generating a visual overlay for the additional medical image data based on the segmentation information of the anatomical structures; and
outputting the additional medical image data and the visual overlay to a display.

7. The method of claim 1, further comprising:
for each 2D image of the plurality of 2D images, dividing the 2D image into a plurality of image patches, wherein each image patch of the plurality of image patches is processed separately by the one or more models.

8. The method of claim 1, wherein the one or more models comprise a video transformer model.

9. The method of claim 8, wherein processing the temporal sequence of the plurality of 2D images using the one or more models comprises providing, to the video transformer model, a model prompt comprising:
example 3D medical image data, wherein a segment of the example 3D medical image data is labeled with a first label; and
an instruction for the video transformer model to output segmentation information in the plurality of 2D images that corresponds to the first label.

10. A system, comprising:
one or more processors; and
a memory coupled to the one or more processors, the memory storing computer program instructions that, when executed by the one or more processors, perform a computer-implemented method comprising:
dividing three-dimensional (3D) medical image data into a plurality of two-dimensional (2D) images;
generating a temporal sequence of the plurality of 2D images;
processing the temporal sequence of the plurality of 2D images using one or more models trained to process videos, wherein the one or more models output segmentation information of anatomical structures in the plurality of 2D images; and
storing the segmentation information in a datastore.

11. The system of claim 10, wherein the anatomical structures comprise at least one of teeth, bones, sinuses, nerves, or gingiva.

12. The system of claim 10, wherein the 3D medical image data comprises at least one of cone beam computed tomography (CBCT) scan data, magnetic resonance imaging (MRI) scan data, or computed tomography (CT) scan data.

13. The system of claim 10, wherein the computer-implemented method further comprises:
generating a visual overlay for the 3D medical image data based on the segmentation information of the anatomical structures; and
outputting the 3D medical image data and the visual overlay to a display.

14. The system of claim 10, wherein the computer-implemented method further comprises:
sending the segmentation information to a remote computing device; and
displaying the segmentation information with the 3D medical image data by the remote computing device.

15. The system of claim 10, wherein the computer-implemented method further comprises receiving the 3D medical image data from a remote computing device.

16. The system of claim 10, wherein the computer-implemented method further comprises:
for each 2D image of the plurality of 2D images, dividing the 2D image into a plurality of image patches, wherein each image patch of the plurality of image patches is processed separately by the one or more models.

17. The system of claim 10, wherein the one or more models comprise a video transformer model.

18. The system of claim 17, wherein processing the temporal sequence of the plurality of 2D images using the one or more models comprises providing, to the video transformer model, a model prompt comprising:
example 3D medical image data, wherein a segment of the example 3D medical image data is labeled with a first label; and
an instruction for the video transformer model to output segmentation information in the plurality of 2D images that corresponds to the first label.

19. A system, comprising:
a first computing device configured to:
divide three-dimensional (3D) medical image data into a plurality of two-dimensional (2D) images;
generate a temporal sequence of the plurality of 2D images; and
process the temporal sequence of the plurality of 2D images using one or more models trained to process videos, wherein the one or more models output segmentation information of anatomical structures in the plurality of 2D images.

20. The system of claim 19, wherein the first computing device is further configured to transmit the segmentation information to a second computing device, the system further comprising:
the second computing device, configured to present the segmentation information on a display.
